(19) United States
(12) Patent Application Publication
(10) Pub. No.: US 2015/0178458 A1
(43) Pub. Date: Jun. 25, 2015

(54) PATIENT HEALTH MANAGEMENT PORTAL

(71) Applicant: VisionTree Software, Inc., San Diego, CA (US)

(72) Inventors: Martin Pellinat, San Diego, CA (US); Alan Da Costa, San Diego, CA (US); Daniel Armstrong, Oxnard, CA (US); Adam Hawkins, San Diego, CA (US)

(21) Appl. No.: 14/593,480

(22) Filed: Jan. 9, 2015

Related U.S. Application Data
(63) Continuation of application No. 11/498,362, filed on Aug. 2, 2006, now abandoned.
(60) Provisional application No. 60/775,578, filed on Feb. 21, 2006.

(51) Int. Cl. G06F 19/00

(52) U.S. Cl. CPC G06F 19/3418; G06F 19/322; G06F 19/327

(57) ABSTRACT

A secure online patient health management portal for patient and payer/provider communication, documentation and improved workflow efficiency. A payer/provider portal provides patient and file management, patient tasking and reminders, calendaring, creation and management of medical condition templates, aggregate report generation and electronic informed consent. A patient portal provides personal health management, task management and reminders, comprehensive access to and management of health records and documentation, calendaring, online payer/provider and institution communication, prescription and finance management and discussion forums.

### RELATED APPLICATIONS

This application claims the benefit of priority in U.S. provisional application Ser. No. 60/775,578, filed on Feb. 21, 2006.

### BACKGROUND OF THE INVENTION

1. Field of the Invention

This invention relates to an online system for patient and payer (i.e. insurance company, health plan) and provider (i.e. physician, hospital, health system) communication, documentation and improved workflow efficiency and, more particularly, relates to a patient health management portal.

2. Description of Related Art

The U.S. healthcare system has historically been a payer/provider-based system revolving around payments and diagnosis and treatment codes for a patient. Patients typically have not had easy access to their healthcare information and records. The rapid adoption of the Internet as a resource for information presents the possibility of a patient-centered healthcare system empowering patients to be involved in their treatment option decisions, include factors such as quality of life in their healthcare decisions, and to take control of managing their healthcare information.

The trends in the current marketplace are towards a more patient-driven system. Patients are demanding increased levels of accessibility to and control of their healthcare information, and the ability for web-based communication with their payers and providers. A recent study found that 83% of patients want a means of online communication with their medical team (i.e. physician, nurse, staff). Hurricane Katrina is a recent, striking example of a patient's need for access to vital information, such as history, prescription, medical finances, insurance, etc., as well as an open line of communication with their payer or provider.

Payers recognize that a shift to a more patient-centered system would result in improved decision-making, outcomes and patient satisfaction. In addition, Medicare and other payers are also beginning to require documentation of quality, efficiency and the patient treatment pathway for payment. Providers would like a better means for electronic data collection and storage to save time and resources.

In view of these factors, an improved system for patient and payer/provider interaction, documentation and communication clearly is needed and has a valuable and timely place in the infrastructure of today's healthcare system.

### SUMMARY OF THE INVENTION

The present invention is a patient health management portal for patient and payer/provider communication, documentation and improved workflow efficiency. The patient health management portal provides for decision and treatment pathway support, storage of vital health records and information, delivery of needed documentation to payers and providers, management of prescriptions and finances, messaging and interaction with the patient's medical team and a forum for patient discussions.

The portal is secure, is introduced to a patient through their payer/provider or as a consumer subscription and seamlessly integrates into the existing workflow of patient health management. It provides a unique value to patients in managing their own health information, as well as to the medical team in the ability to collect outcomes data and to document quality and efficiency in delivering best practices. The portal serves as a payer/provider administrative “dashboard” for real-time performance and treatment updates.

Accordingly, one embodiment of the invention is a secure online patient health management portal including a payer/provider portal with means for patient management and a patient portal with means for personal health management.

Another embodiment of the invention is a secure Internet-based method for managing healthcare. Payer/provider access to a plurality of patient accounts is provided. Electronic forms and surveys to be completed by a patient at various stages of treatment are provided. The patient is informed of a medical condition, treatment options, risks and benefits, and their signature and consent is electronically captured and stored. The patient is assisted with a treatment decision by obtaining ratings of importance of benefits, risks and concerns associated with each treatment option and calculating a score for each treatment option. Patient, medical condition and custom aggregate reports are generated. A patient can download his/her health care records, and can manage and track drug prescriptions and healthcare-related expenses.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a screenshot of a patient health management portal login screen of the present invention.

FIGS. 2-1 and 2-2 are screenshots of a payer/provider home screen of the present invention, and FIG. 2 depicts the relationship between the screenshots in FIGS. 2-1 and 2-2.

FIGS. 3-1 and 3-2 are screenshots of a patient administration screen of present invention, and FIG. 3 depicts the relationship between the screenshots in FIGS. 3-1 and 3-2.

FIGS. 4-1 and 4-2 are screenshots of an exemplary assessment survey from a patient's task list of the present invention, and FIG. 4 depicts the relationship between the screenshots in FIGS. 4-1 and 4-2.

FIGS. 5A-1, 5A-2, 5B-1, and 5B-2 are screenshots of dynamic informed consent forms of the present invention, FIG. 5A depicts the relationship between the screenshots in FIGS. 5A-1 and 5A-2, and FIG. 5B depicts the relationship between the screenshots in FIGS. 5B-1 and 5B-2.

FIGS. 6A, 6B-1, 6B-2, 6C-1, 6C-2, 6D-1, 6D-2, 6E-1, and 6E-2 are screenshots of a decision support program of the present invention, FIG. 6B depicts the relationship between the screenshots in FIGS. 6B-1 and 6B-2, FIG. 6C depicts the relationship between the screenshots in FIGS. 6C-1 and 6C-2, FIG. 6D depicts the relationship between the screenshots in FIGS. 6D-1 and 6D-2, and FIG. 6E depicts the relationship between the screenshots in FIGS. 6E-1 and 6E-2.

FIGS. 7-1 and 7-2 are screenshots of a new patient screen of the present invention, and FIG. 7 depicts the relationship between the screenshots in FIGS. 7-1 and 7-2.

FIGS. 8A, 8B-1, 8B-2, and 8C are screenshots of medical condition template creation screens of the present invention, and FIG. 8B depicts the relationship between the screenshots in FIGS. 8B-1 and 8B-2.

FIG. 9 is a screenshot of a calendar template creation screen of the present invention.

FIGS. 10-1 and 10-2 are screenshots of a file manager of the present invention, and FIG. 10 depicts the relationship between the screenshots in FIGS. 10-1 and 10-2.

FIGS. 11-1 and 11-2 are screenshots of a calendar view of the present invention, and FIG. 11 depicts the relationship between the screenshots in FIGS. 11-1 and 11-2.

FIGS. 12A, 12B, 12C-1, 12C-2, 12D-1, 12D-2, 12D-3, 12E-1, 12E-2, and 12E-3 are screenshots of reporting functions provided by the present invention, FIG. 12C depicts the relationship between the screenshots in FIGS. 12C-1 and 12C-2, FIG. 12D depicts the relationship between the screenshots in FIGS. 12D-1, 12D-2, and 12D-3, and FIG. 12E depicts the relationship between the screenshots in FIGS. 12E-1, 12E-2, and 12E-3.

FIGS. 13-1 and 13-2 are screenshots of an interactive treatment pathway diagram of the present invention, and FIG. 13 depicts the relationship between the screenshots in FIGS. 13-1 and 13-2.

FIGS. 14-1 and 14-2 are screenshots of a patient portal home screen of the present invention, and FIG. 14 depicts the relationship between the screenshots in FIGS. 14-1 and 14-2.

FIG. 15 is a screenshot of patient reminder and task fields of the present invention.

FIGS. 16A-B are screenshots of nurse and appointment messaging tools of the present invention.

FIG. 17 is a screenshot of a prescription management tool of the present invention.

FIGS. 18-1 and 18-2 are screenshots of a healthcare finance management tool of the present invention, and FIG. 18 depicts the relationship between the screenshots in FIGS. 18-1 and 18-2.

### DETAILED DESCRIPTION OF THE INVENTION

The present invention provides an online patient health management portal for patient and medical team communication, documentation and improved workflow efficiency. The system includes a payer/provider portal for various functions including patient and file management, patient tasking and reminders, calendaring, creation and management of medical condition templates, aggregate report generation and electronic informed consent. The system also includes a patient portal for various functions including personal health management, task management and reminders, comprehensive access to health records and documentation, calendaring, online communication with their medical team, online visits, prescription and finance management and discussion forums.

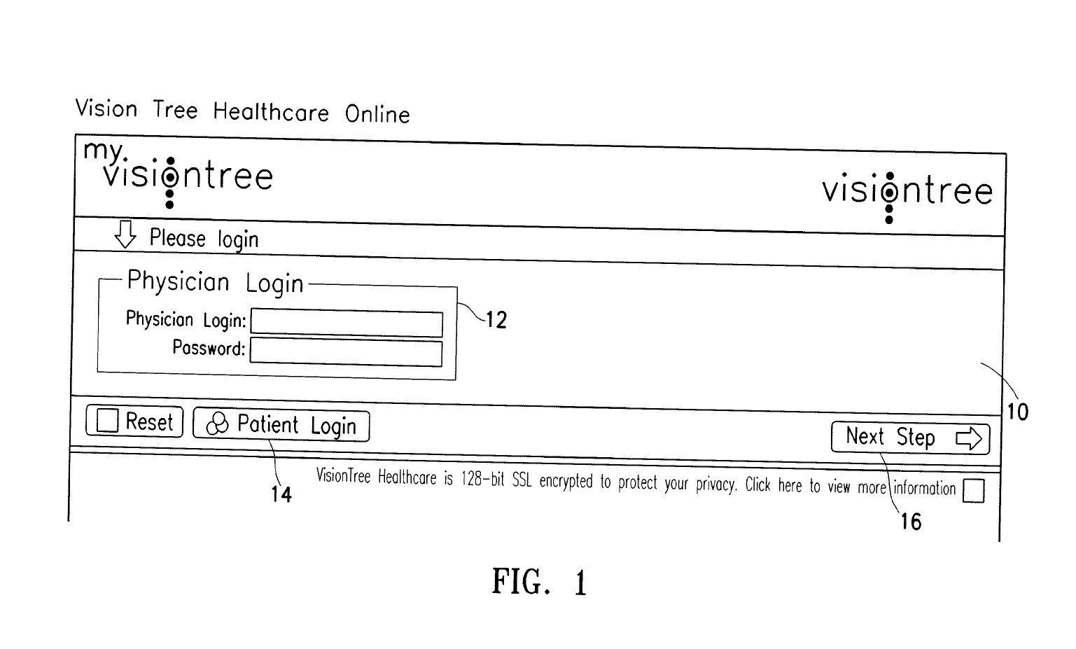

The portal is stored on a server or other computer medium and is accessed by logging on to a secured website (HIPAA compliant security). Client (i.e. patient) to server interaction is ensured at a minimum of 128-bit SSL encryption. The server has its own security certificate and data encryption. In one embodiment, the portal may be accessed at www.myvisiontree.com. FIG. 1 illustrates an example of a login screen 10 that may be provided for the medical team, patients and approved guests. A medical team login area 12 and a patient login are 14 are provided. The medical team may login, for example, by providing identity information such as a username and password and pressing return or clicking a “next step” or other appropriate tab 16. The patient health management portal is described in detail below, first from the payer/provider perspective and then from the patient perspective.

Payer/Provider Portal

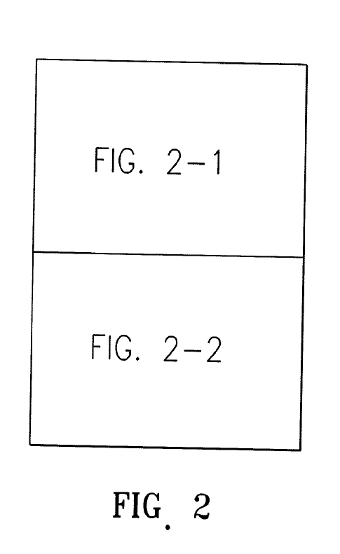

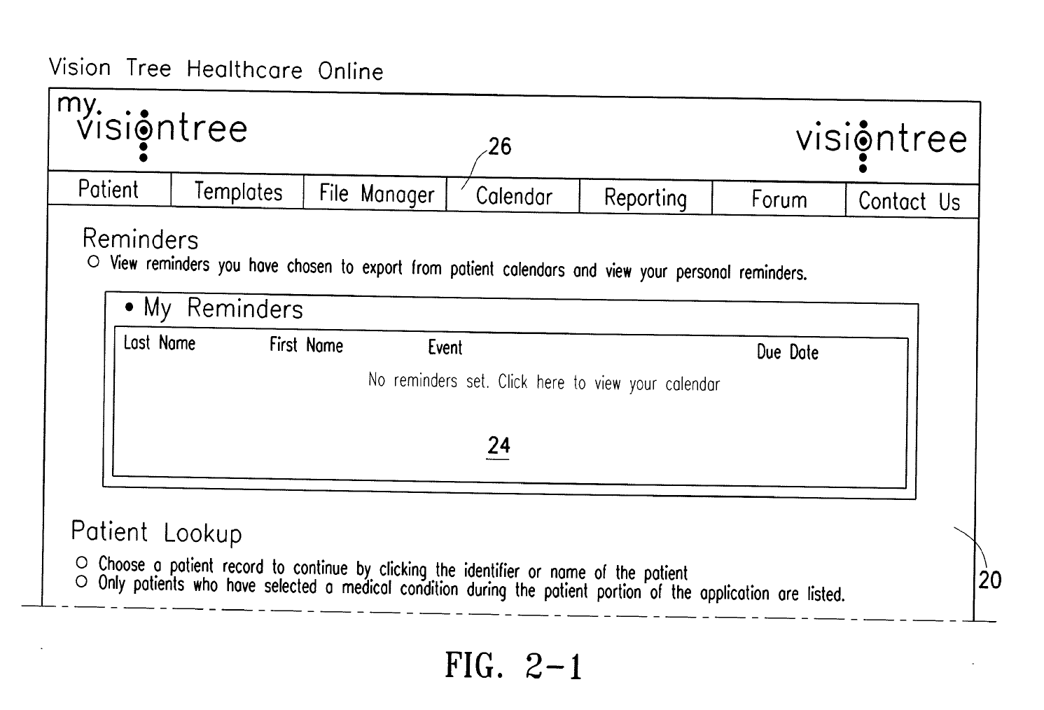

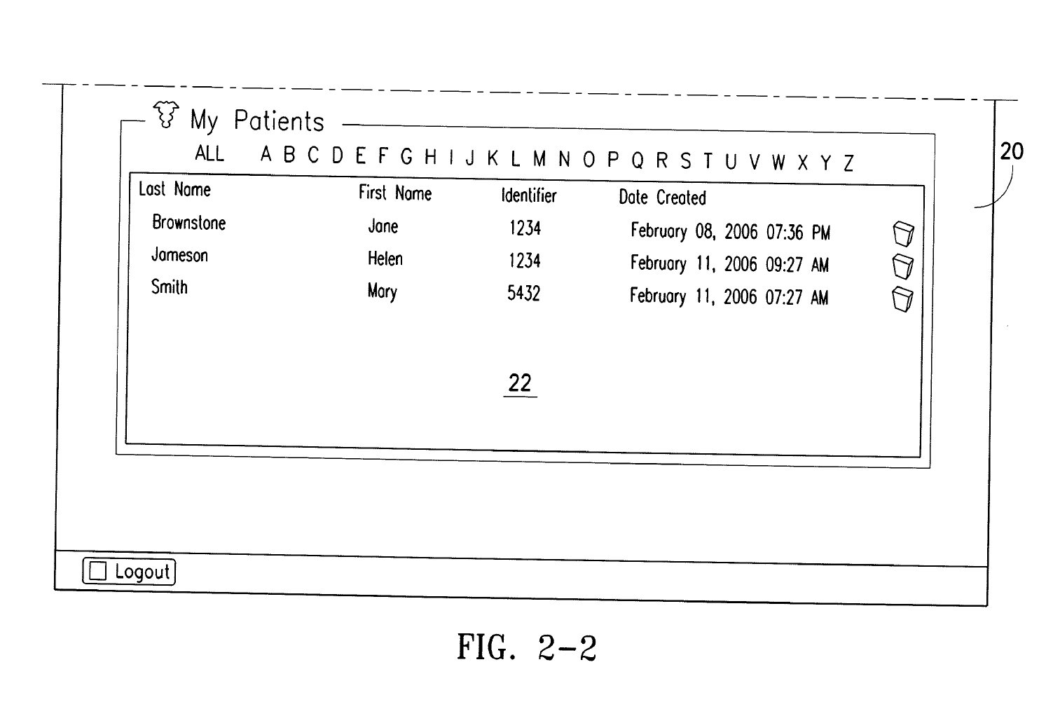

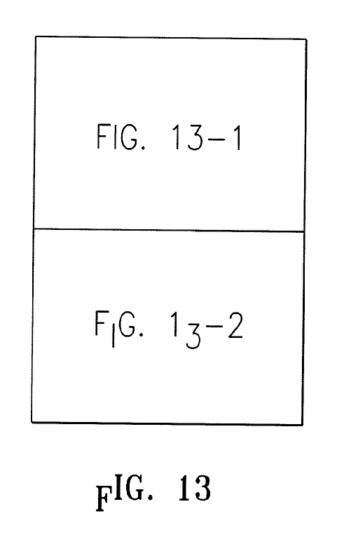

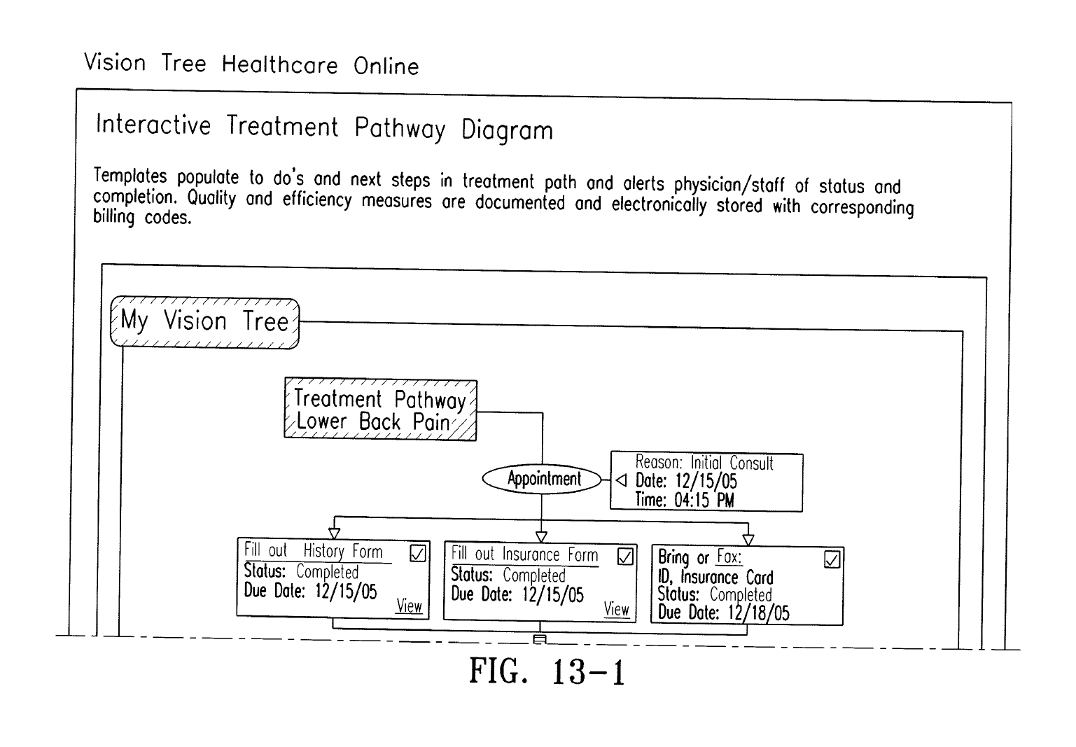

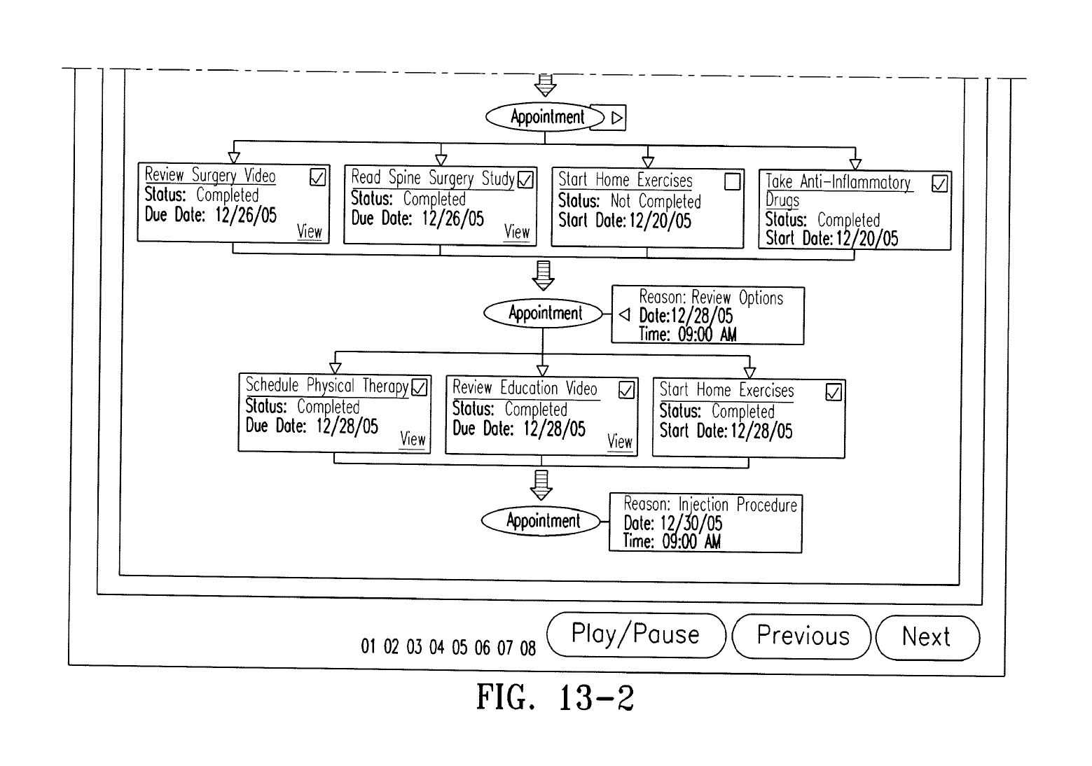

The payer/provider's portal provides patient management features such as assessments, forms and files online, a web-based reminder and calendar system, dynamic transcription of data collected electronically, administrative management of a real-time patient discussion forum and the ability to export follow-ups to Microsoft® Outlook®. The payer/provider's portal also provides dynamic informed consent features. Templates for one-step documentation are provided. Options, risks and benefits are presented to the patient, and the patient's signature is captured electronically. Patient education features include presentation of evidence-based options, links to clinical data, literature and resources and access to payer/provider files and media. Reporting features and tools include the abilities to sort and filter data by patient, condition and codes such as ICD-9 and CPT codes, aggregate assessment reports, track outcomes and run custom queries. These and other features are described below with reference to FIGS. 2-13.

Once logged m, the payer/provider is presented with a home screen 20 including a patient lookup portion 22 that provides access to patient accounts (FIG. 2). The payer/provider may sort and choose patient records by clickable fields such as patient name, patient ID, record ID, date of creation and other appropriate identifiers. Home screen 20 may include other features, such as daily reminders 24 and calendar items. In this regard, reminders may be exported from the payer/provider's calendar, as well as patient, staff and other appropriate calendars. Home screen 20 as well as other screens of the portal provide for easy navigation to other patient management and reporting tools via clickable tabs 26 (i.e., patients, templates, file manager, calendar, reports, discussion forums, support and other tools).

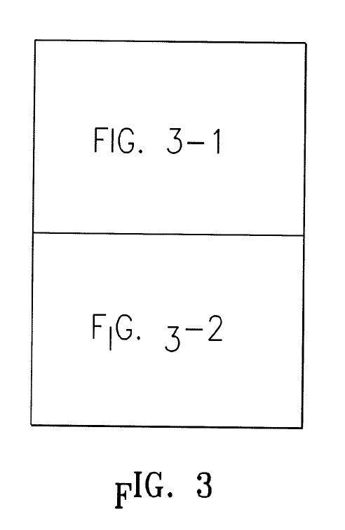

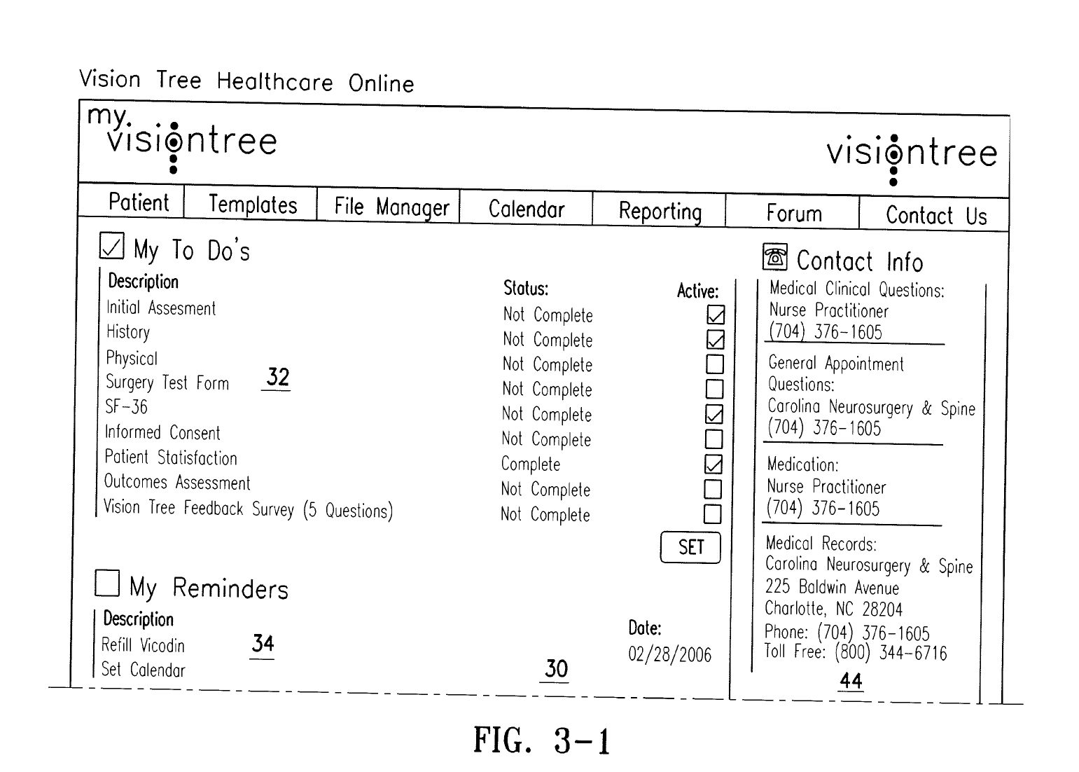

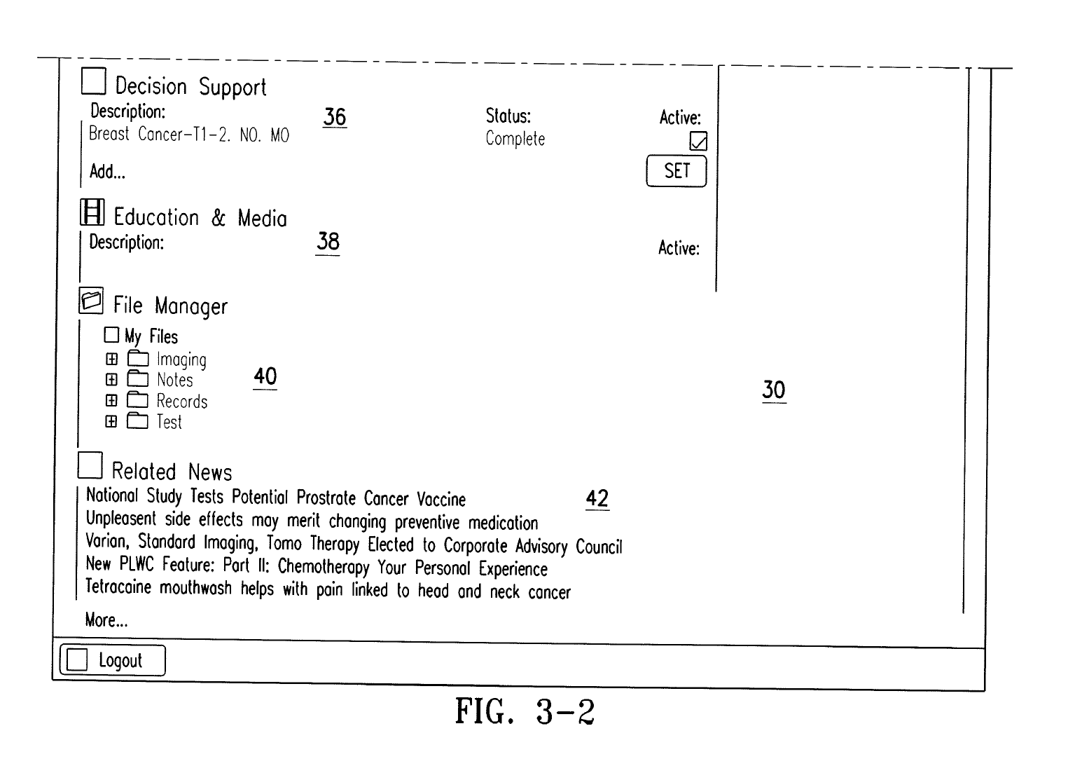

Once a patient account is selected from home screen 20, the patient account is displayed on patient administration screen 30 (FIG. 3). Here, the payer/provider can view various aspects of patient administration such as to do tasks 32, patient reminders 34, decision support templates 36, targeted education and media 38, file manager 40, related news 42 and contact information 44. It should be understood that these are exemplary aspects of patient administration, and that other appropriate administration tools could be provided in the portal. The status of reminder and to do tasks may be indicated (complete or not complete), and items may be activated or deactivated by appropriate setting of a checkbox. The to dos, reminders and decision support may be created and populated by the use of templates, as will be described.

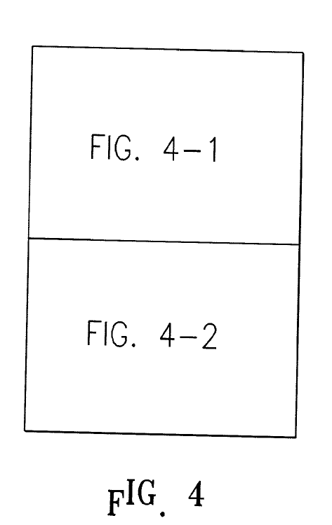

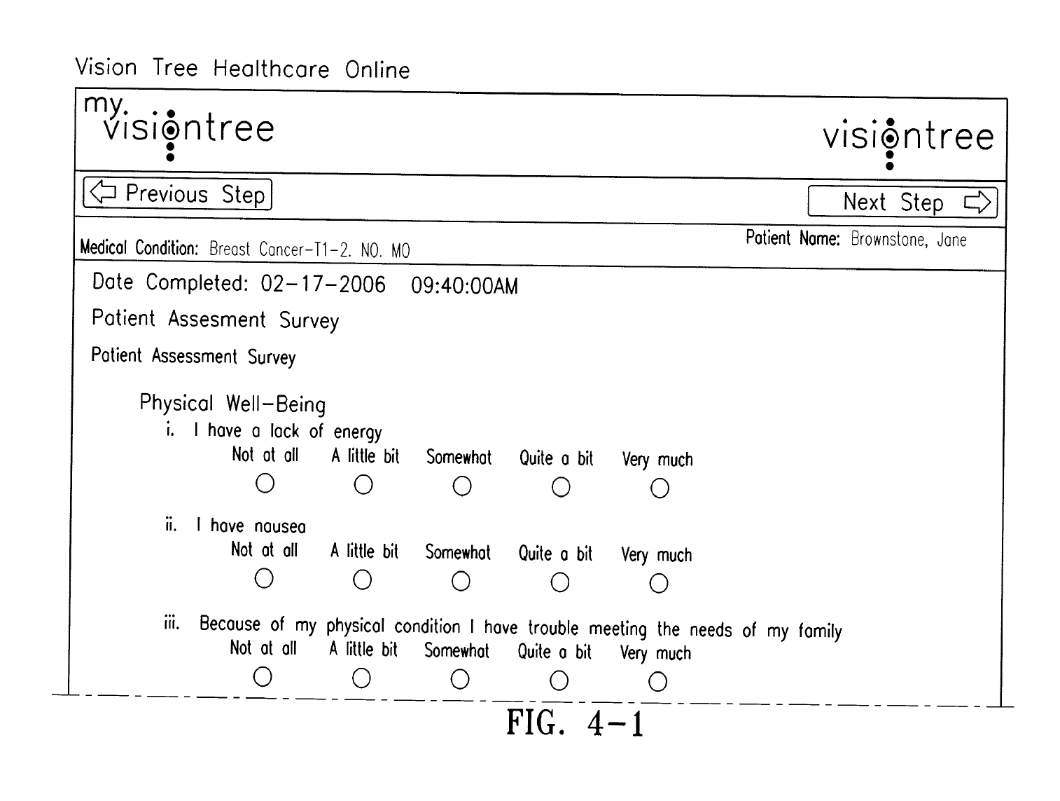

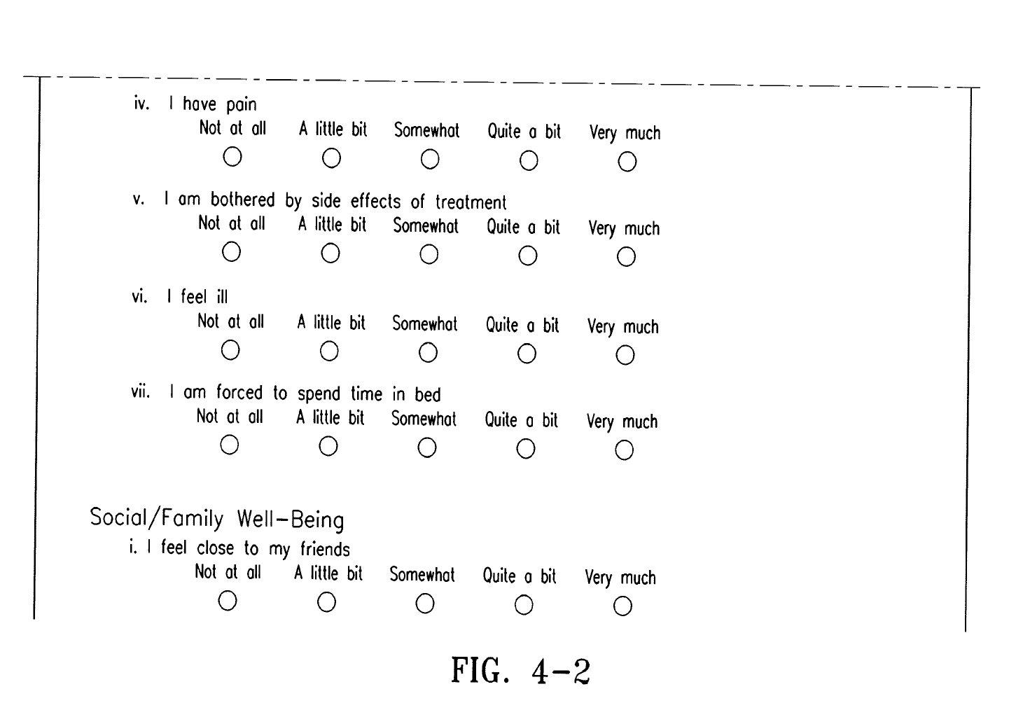

Tasks 32 may comprise various electronic forms and surveys that the patient is to complete at various stages of their treatment. These may be standard forms or payer/provider-specific forms created by use of templates. For example, an assessment survey may be provided, as shown in FIG. 4. Other data may be gathered by the forms and surveys provided in the tasks fields 32, including without limitation patient history, physical, satisfaction, outcomes assessment.

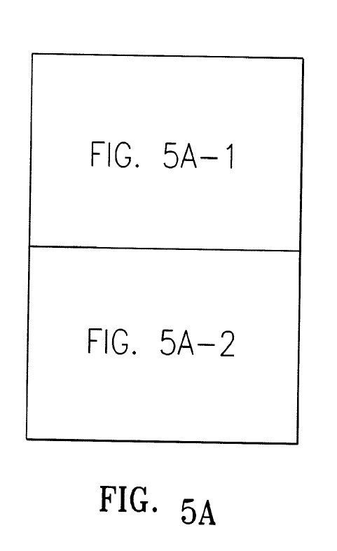

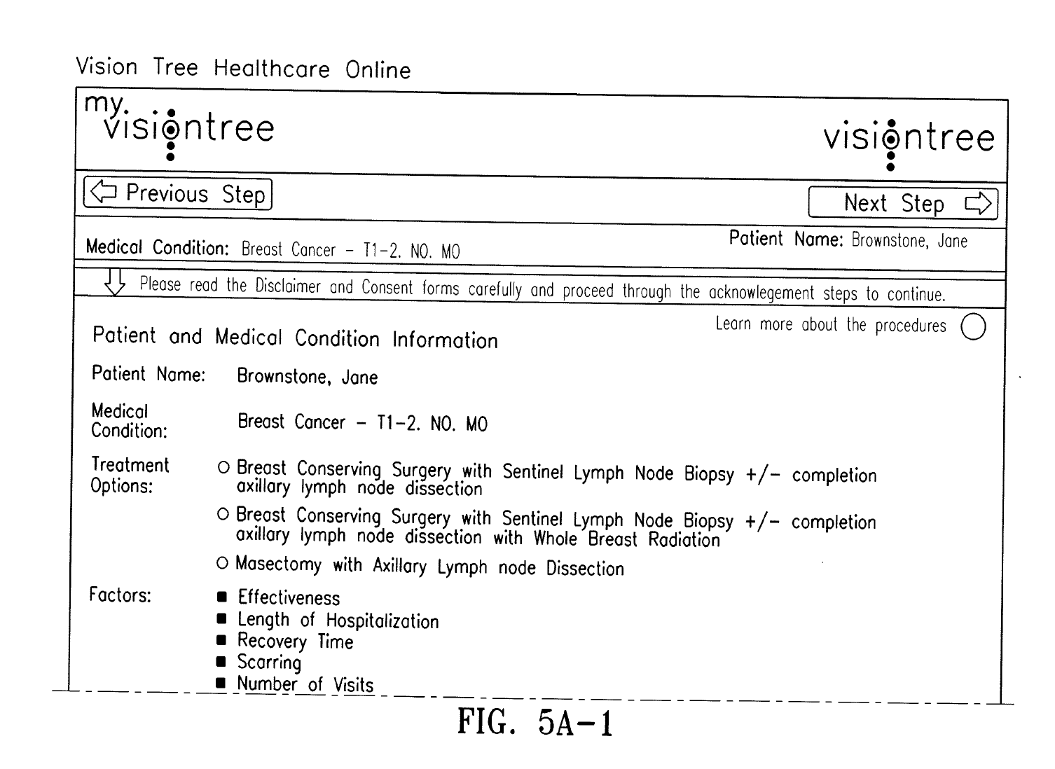

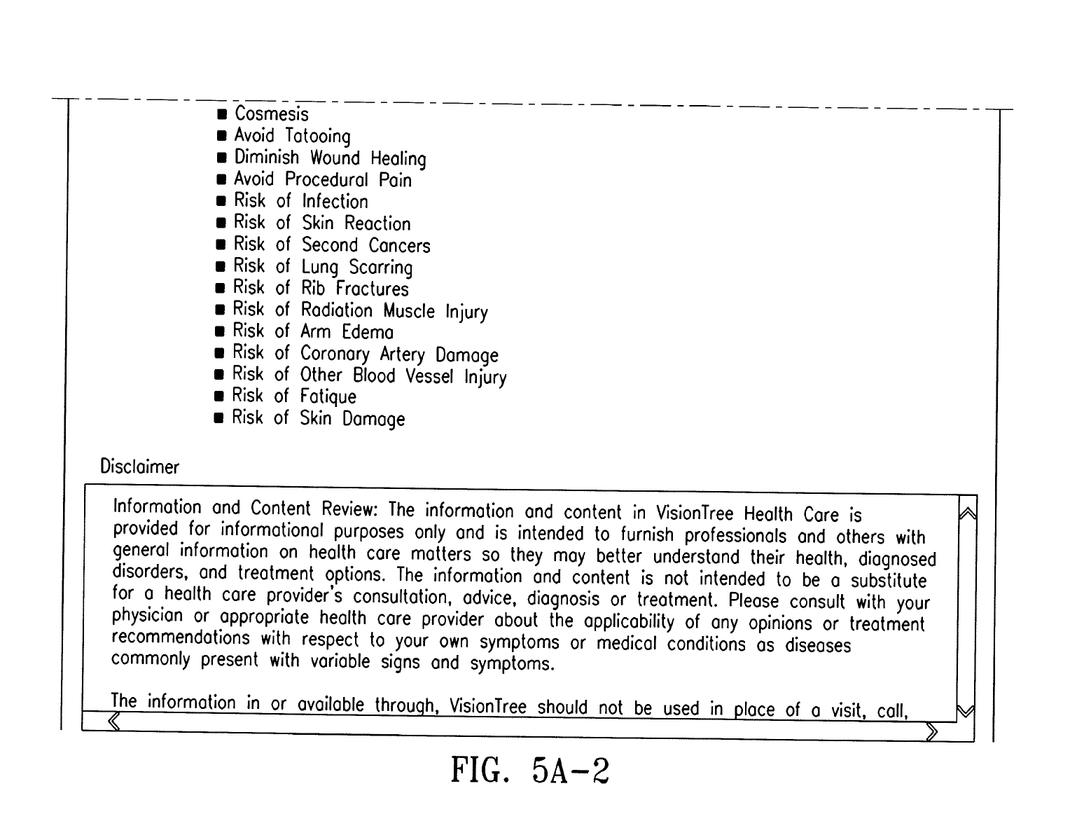

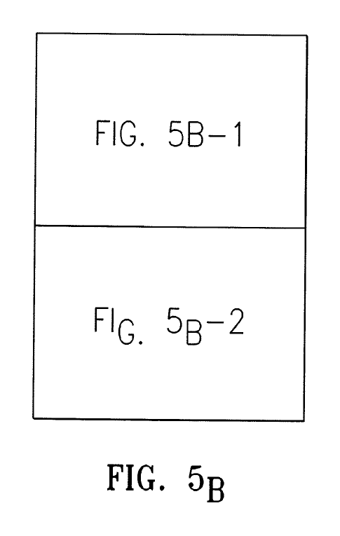

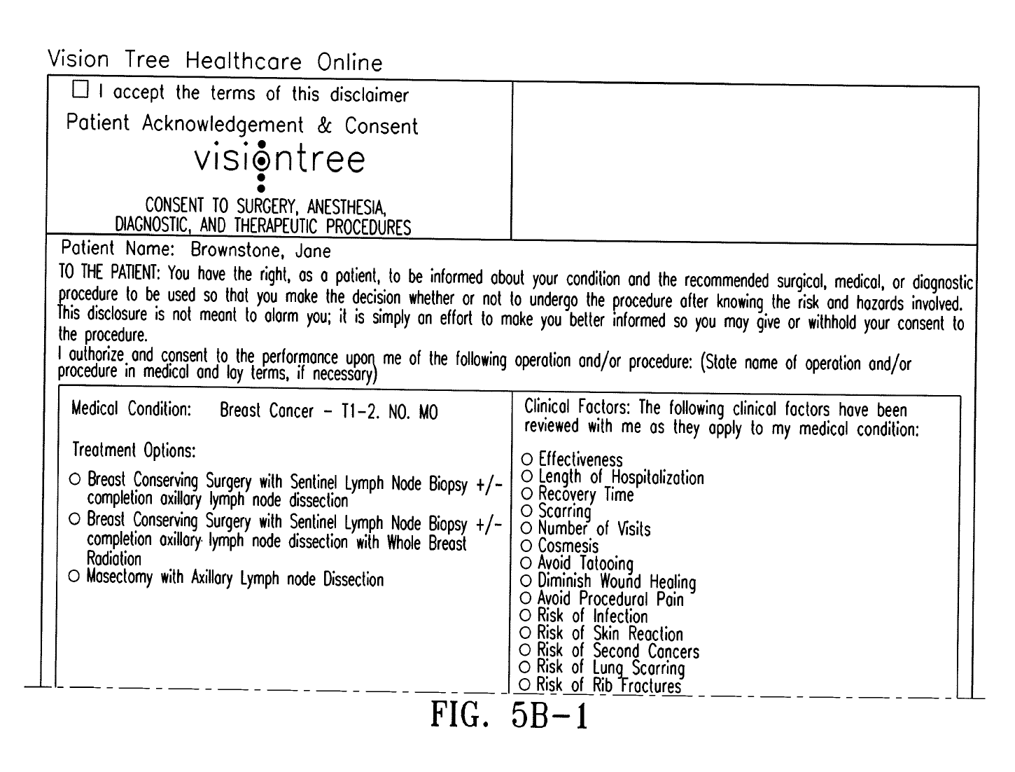

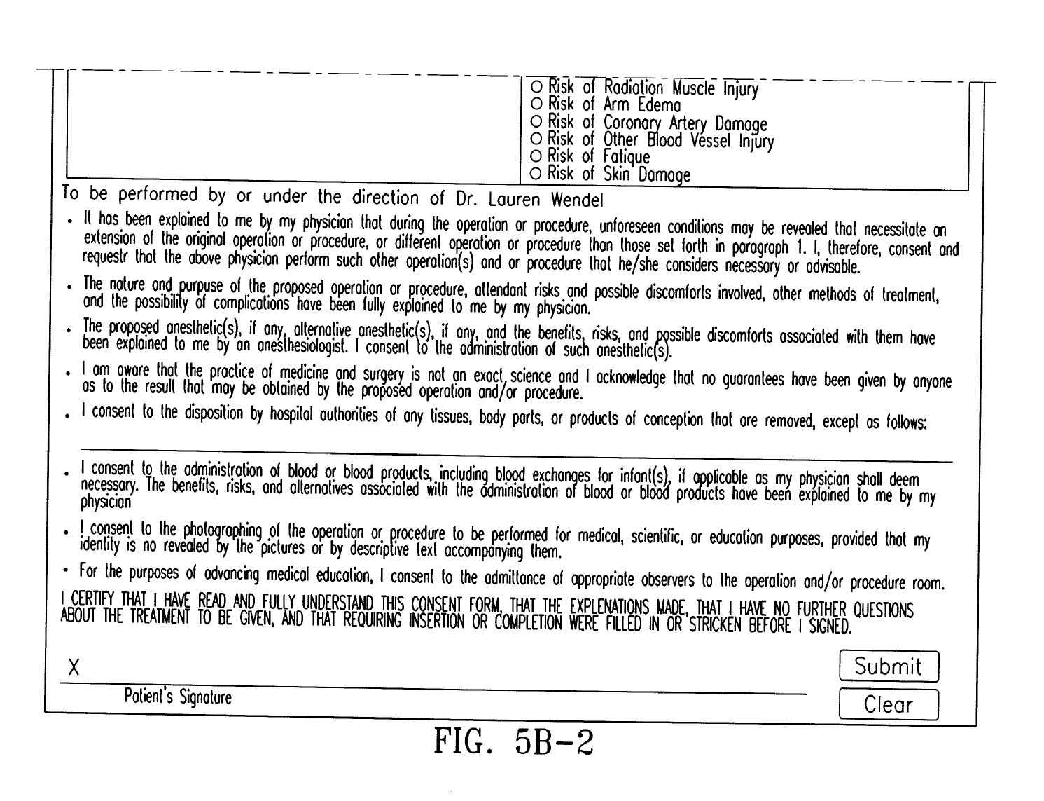

An important aspect of this invention is the ability to obtain dynamic informed consent from the patient. This feature may be provided, as illustrated, in the task fields 32. The informed consent document is dynamically linked to the treatment option selected. As shown in FIGS. 5A-B, the patient is presented with and can review the medical condition, treatment options, risks and benefits, and their signature is captured and stored electronically.

Reminders 34 may include important items keyed to a date such as refilling prescriptions. In this regard, the payer/provider may choose to add additional reminders by clicking the appropriate selection.

The decision support field 36 is an important aspect of the portal. Here, by use of a decision engine, the payer/provider may guide and assist the patient in selecting the best treatment option from those available using a step-by-step decision making process that evaluates the various factors (risks and benefits) involved in the decision. In this regard, reference is made to applicant's U.S. Pat. No. 6,917,928 and pending application Ser. No. 10/845,301 (US 2004/0220834) to decision engine technology, which are incorporated herein by reference.

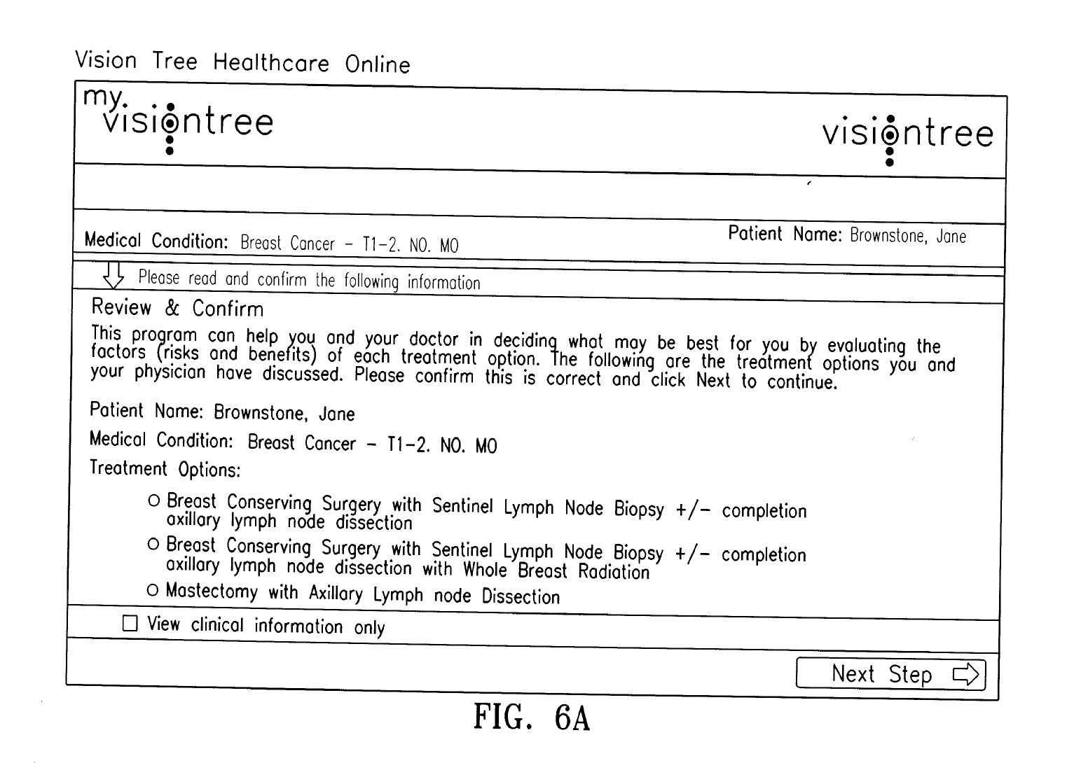

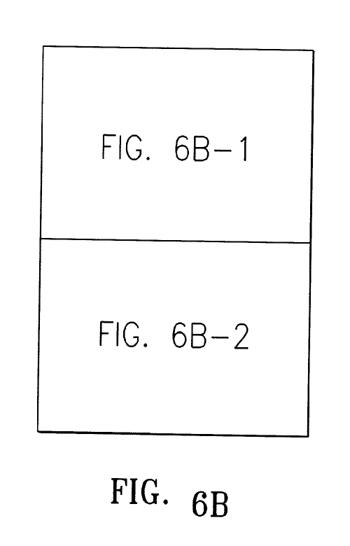

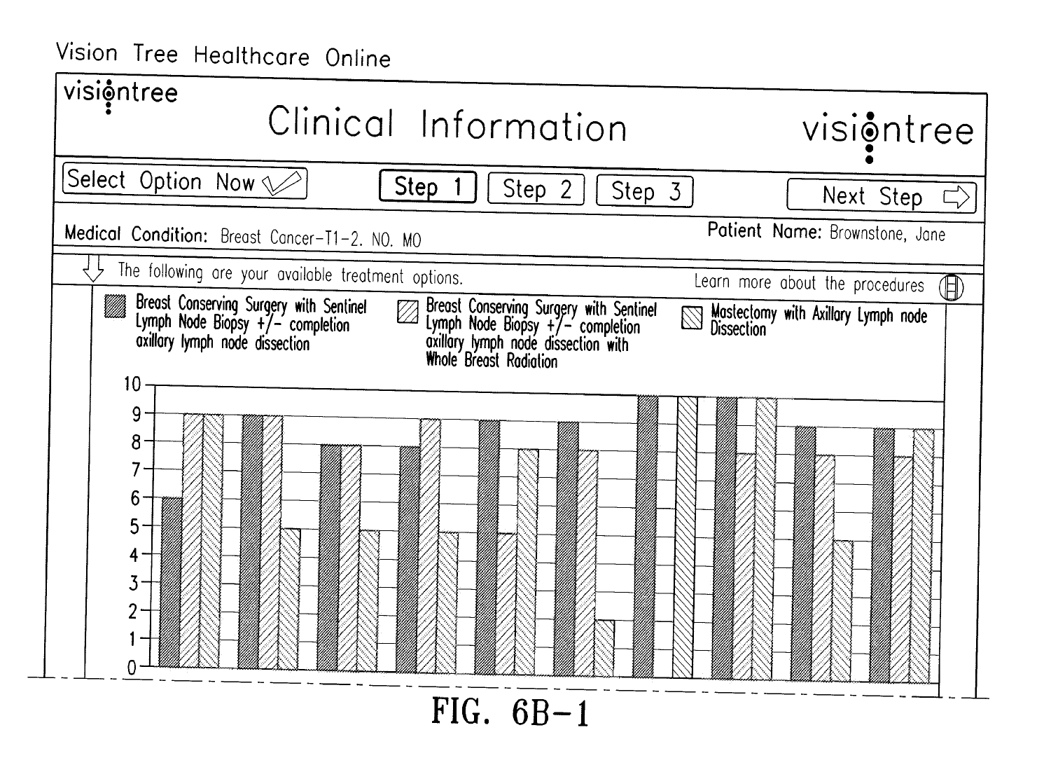

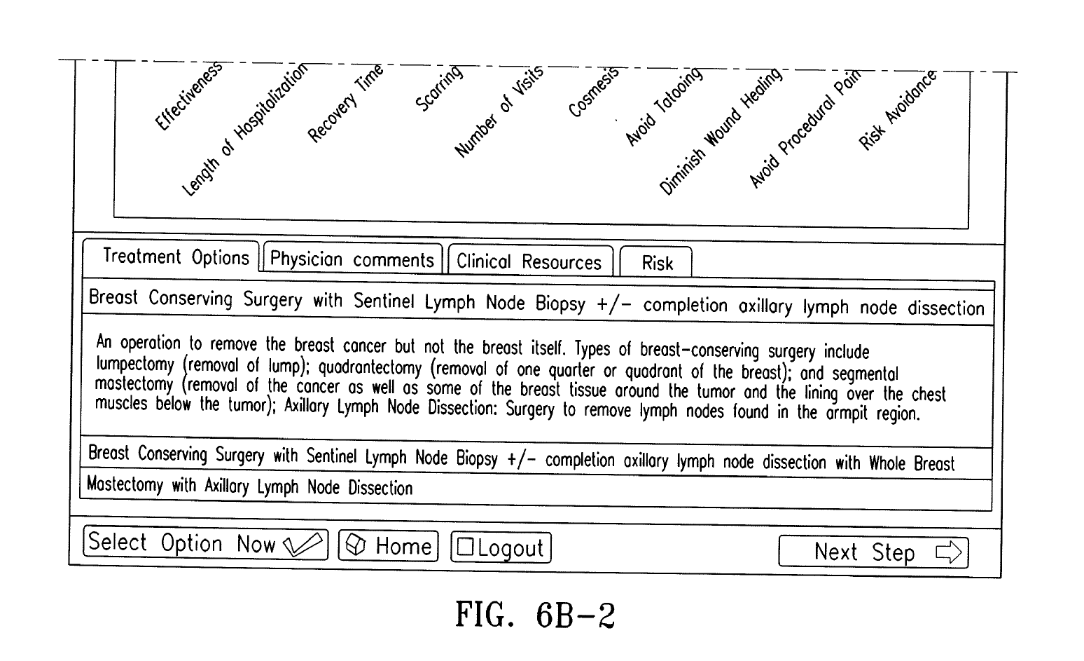

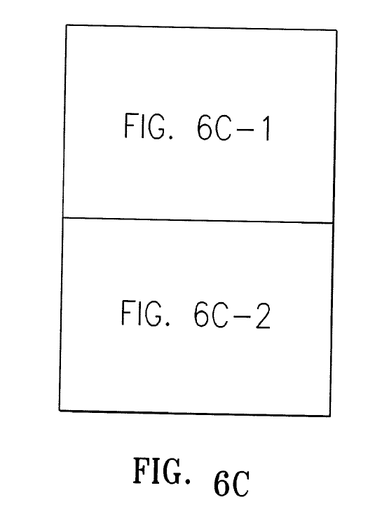

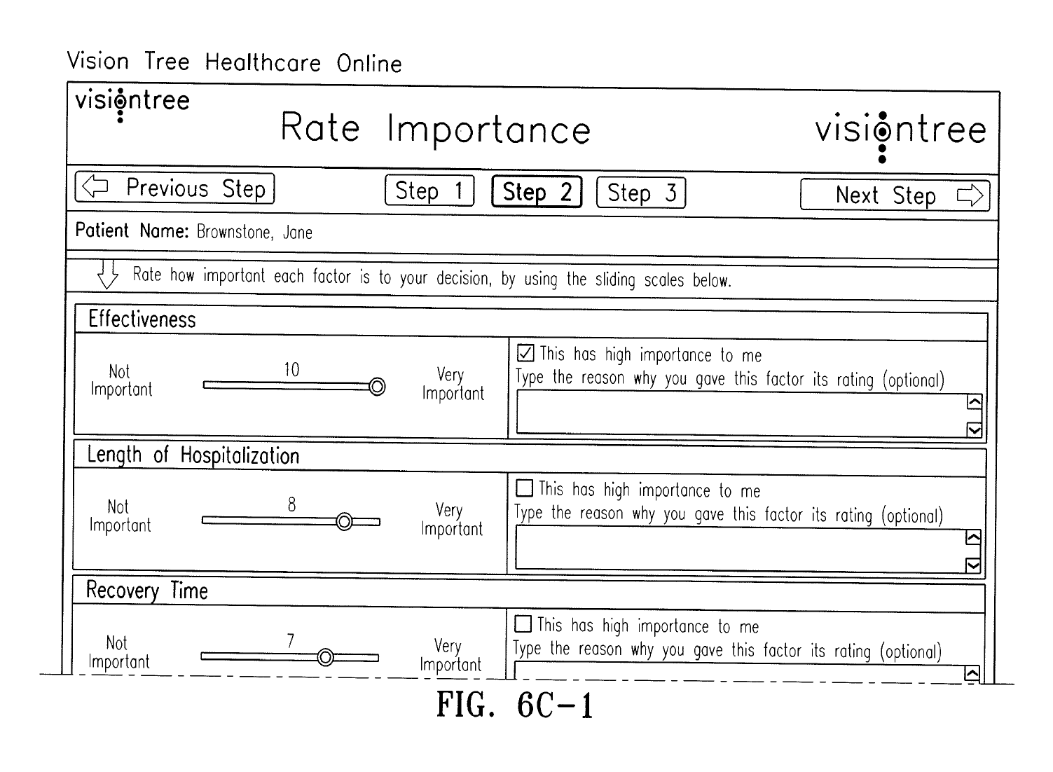

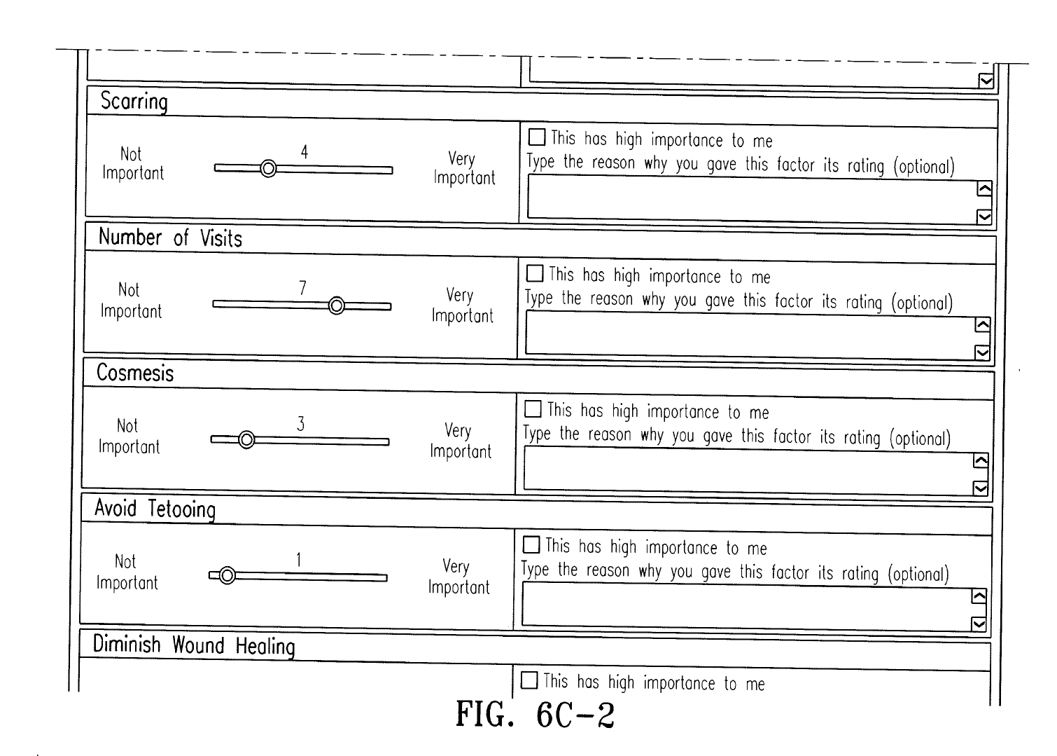

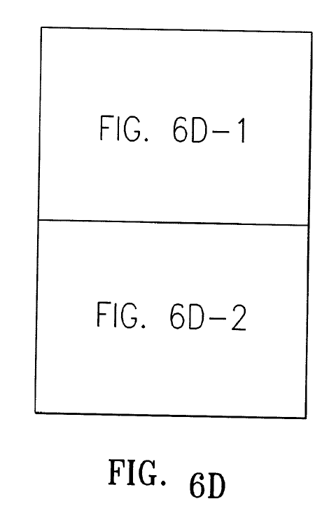

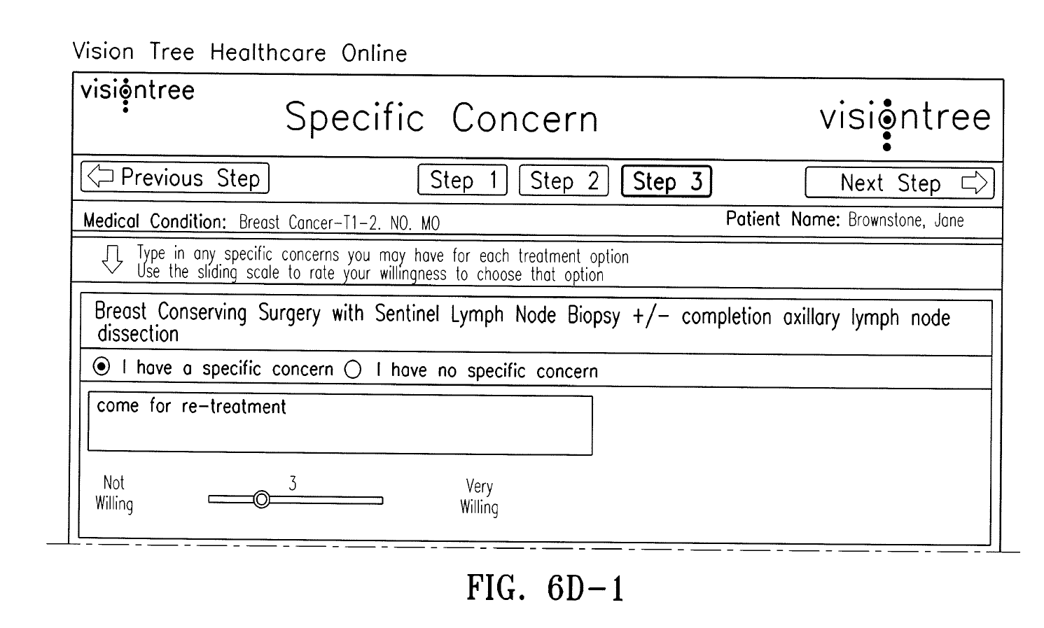

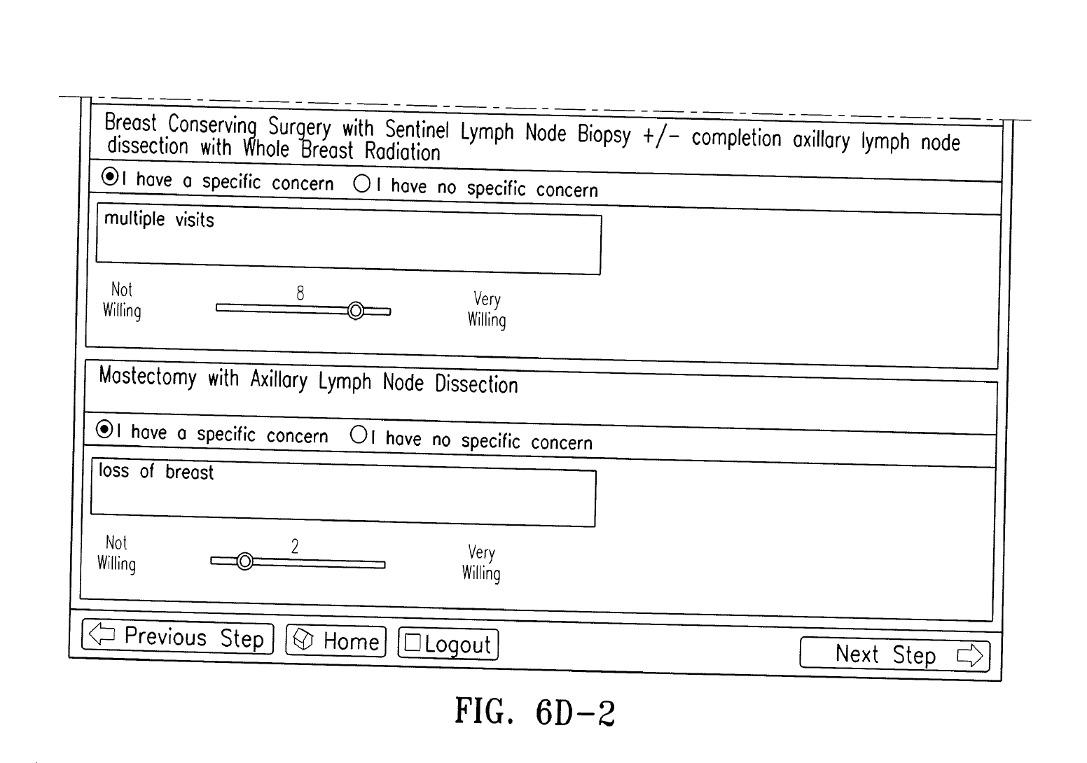

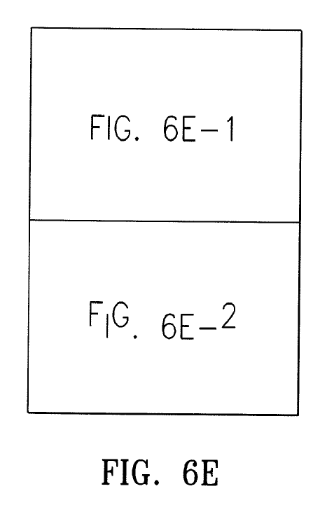

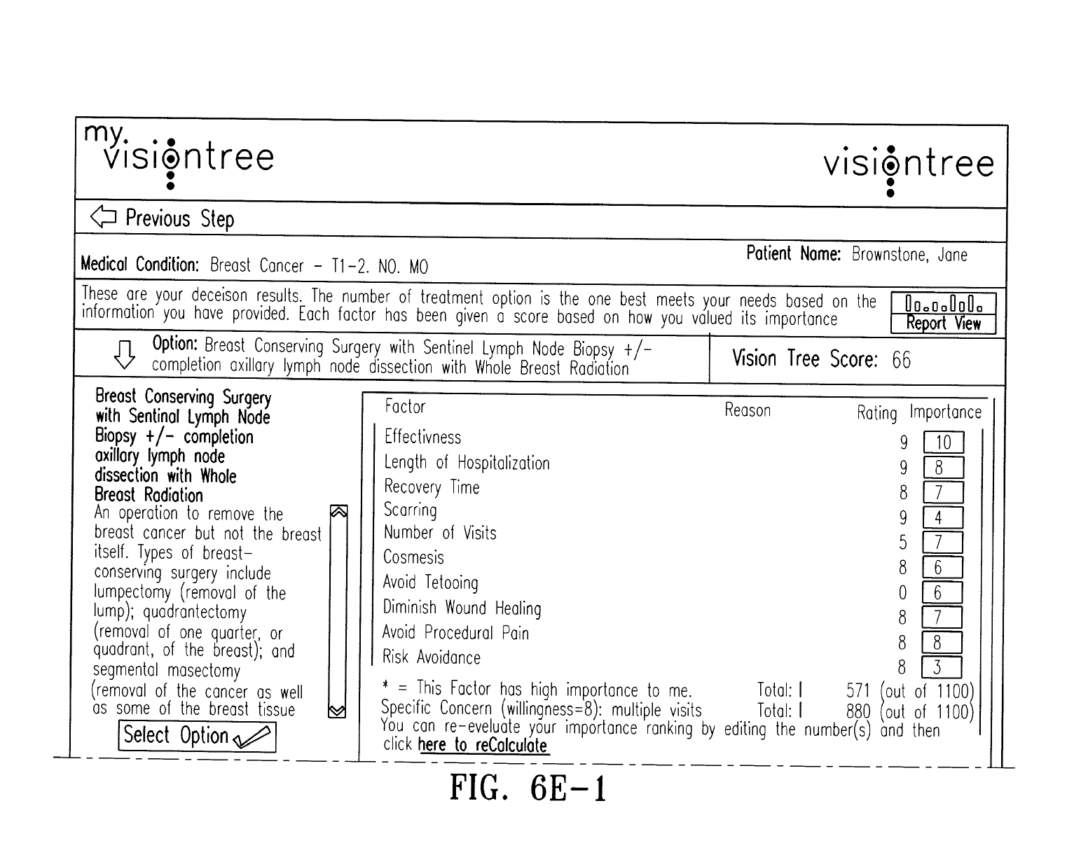

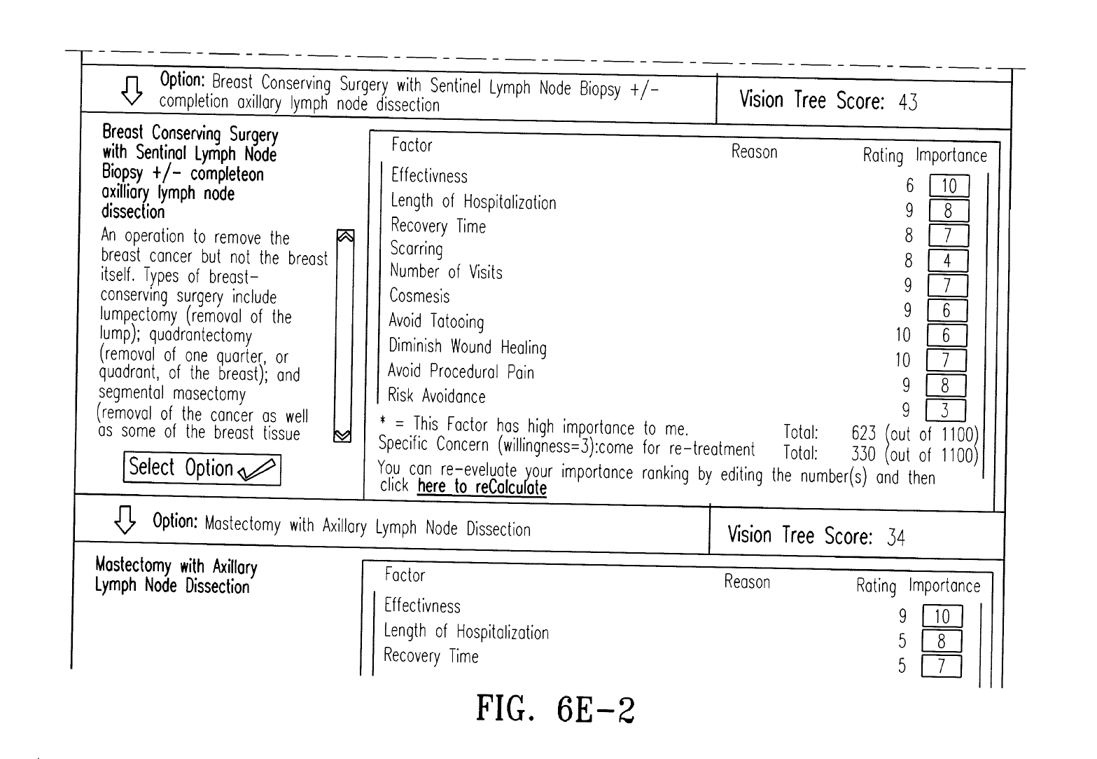

FIGS. 6A-E illustrate an exemplary decision support process that may be provided in field 36. FIG. 6A reviews and confirms the medical condition and the available treatment options. FIG. 6B shows clinical data associated with each option (i.e. effectiveness, length of hospital stay, scarring, etc.). As illustrated, the data may be presented in a user friendly format such as a bar graph. FIG. 6C illustrates the decision making step by which the user is asked to rate the importance of each factor associated with the treatment options. FIG. 6D illustrates the decision making step by which users may identify and rate specific concerns (i.e., loss of breast) that may be associated with a condition (breast cancer). FIG. 6E shows the results of the decision making process, with scores based on the values assigned to the risks/benefits/special concerns associated with the treatment options.

Education, media and news fields 38 and 42 may provide links or other access to materials and news of relevance to a particular patient and medical condition. File manager 40 allows the payer/provider to upload, create and manage files associated with the patient such as tests, notes, etc.

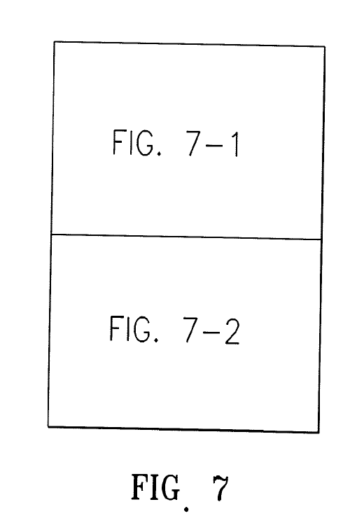

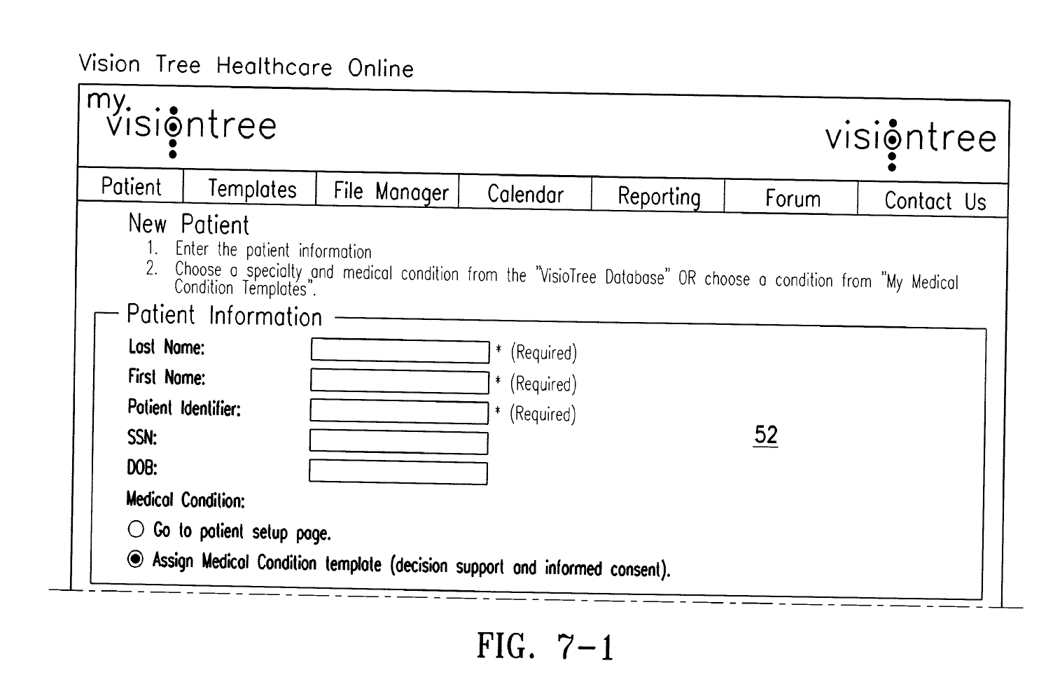

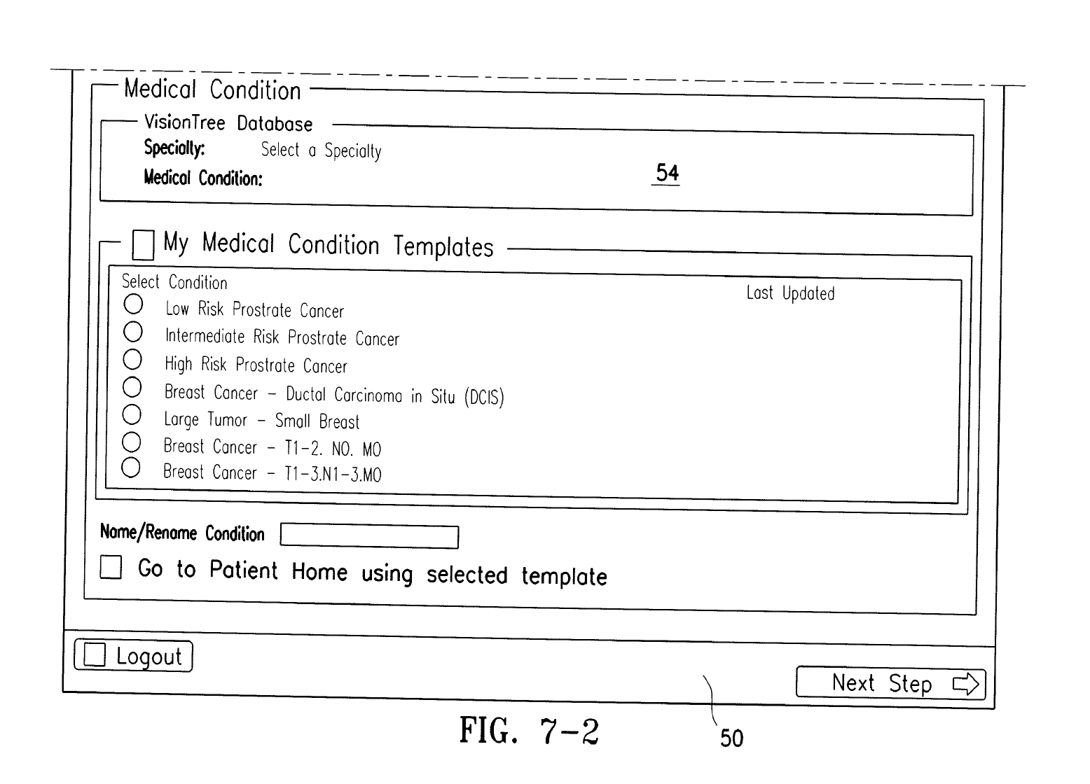

To create a new patient account, a payer/provider selects a “new patient” option that may be provided, for example, on a drop-down menu from the patient tab. FIG. 7 illustrates an exemplary new patient screen 50. A patient information area 52 provides fields for entry of information such as name, ID number, social security number and date of birth. A medical condition area 54 provides appropriate fields for associating a specialty area and medical condition with the patient. In addition to manual entry, these fields may be populated through a feed of this information from an existing electronic medical record (EMR). The medical condition may be selected from pre-stored conditions in a database via a drop-down menu or, alternatively, may be selected from medical condition templates created by the payer/provider. In connection with creating the new patient account, the payer/provider may create and print a Patient ID card to be given to the patient with identification information allowing them to access the patient health management portal.

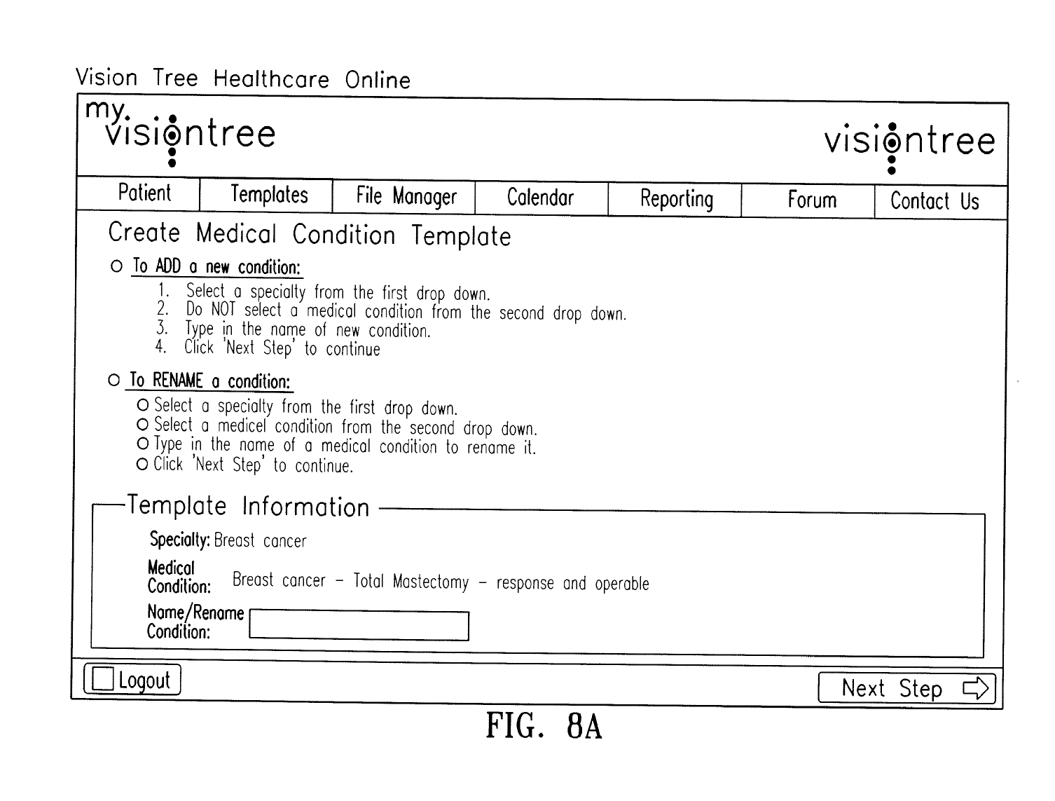

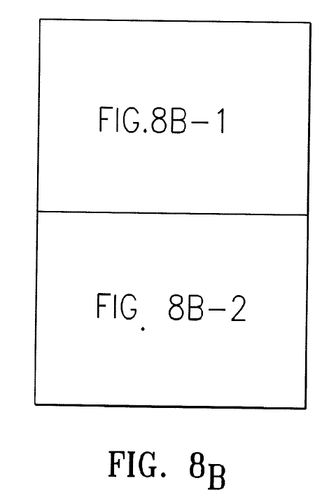

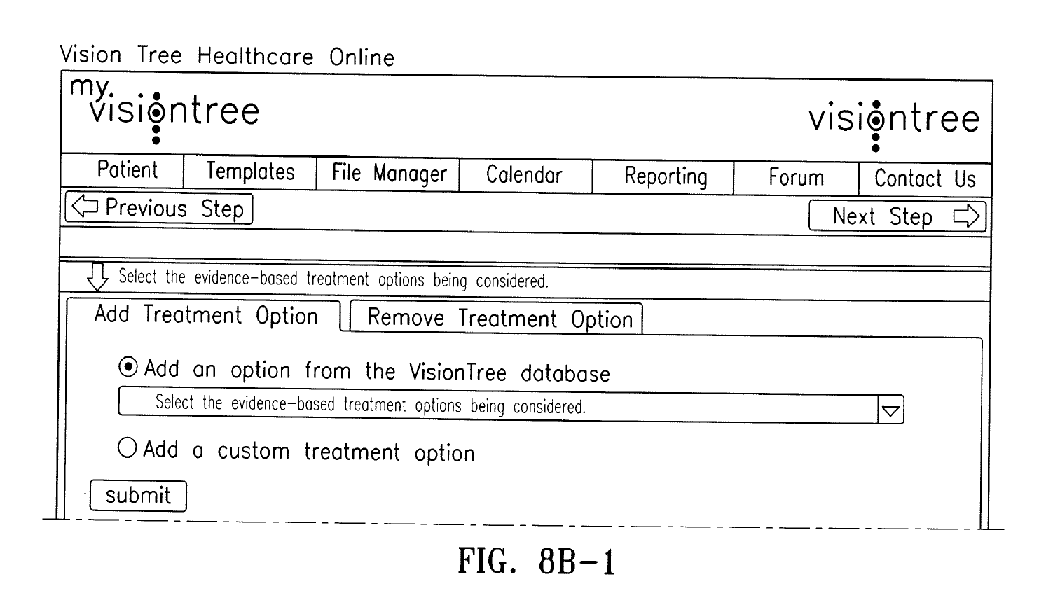

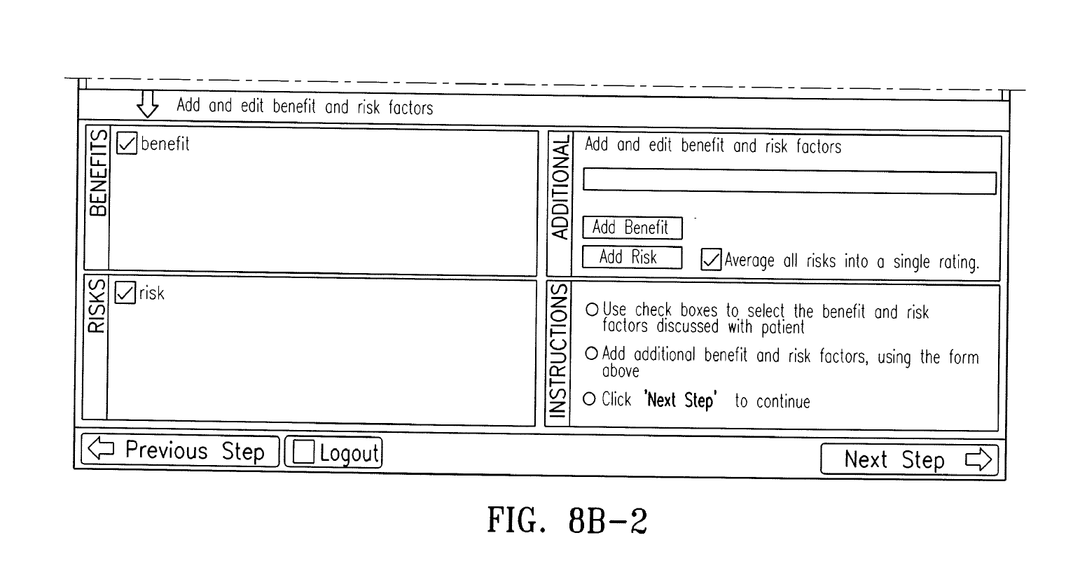

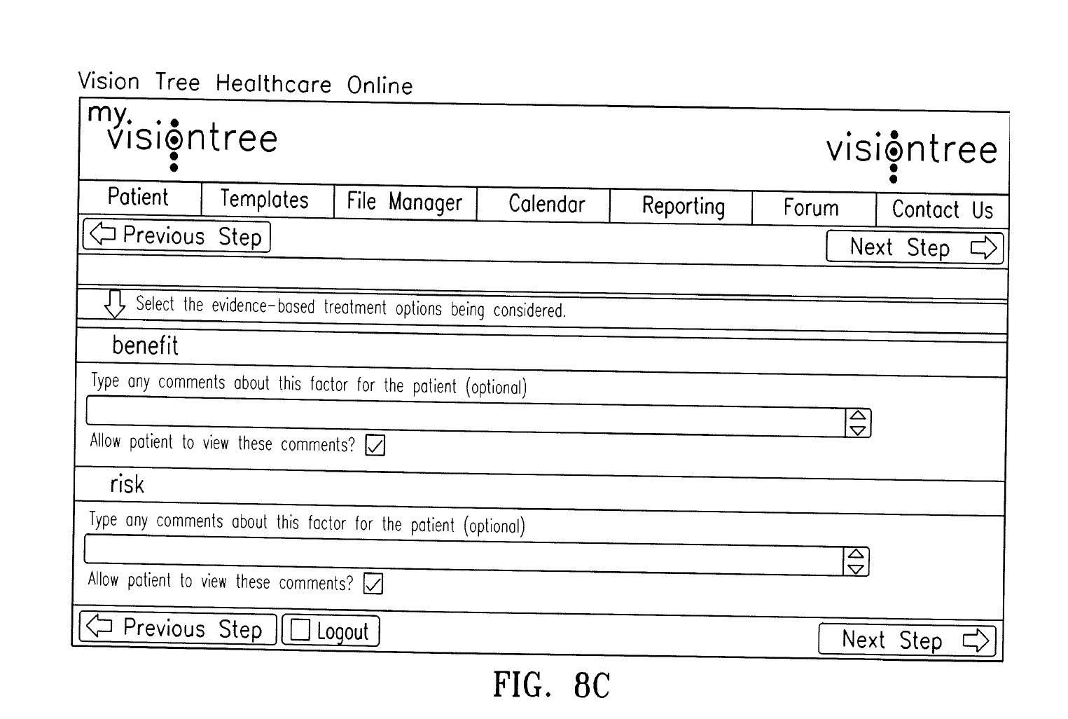

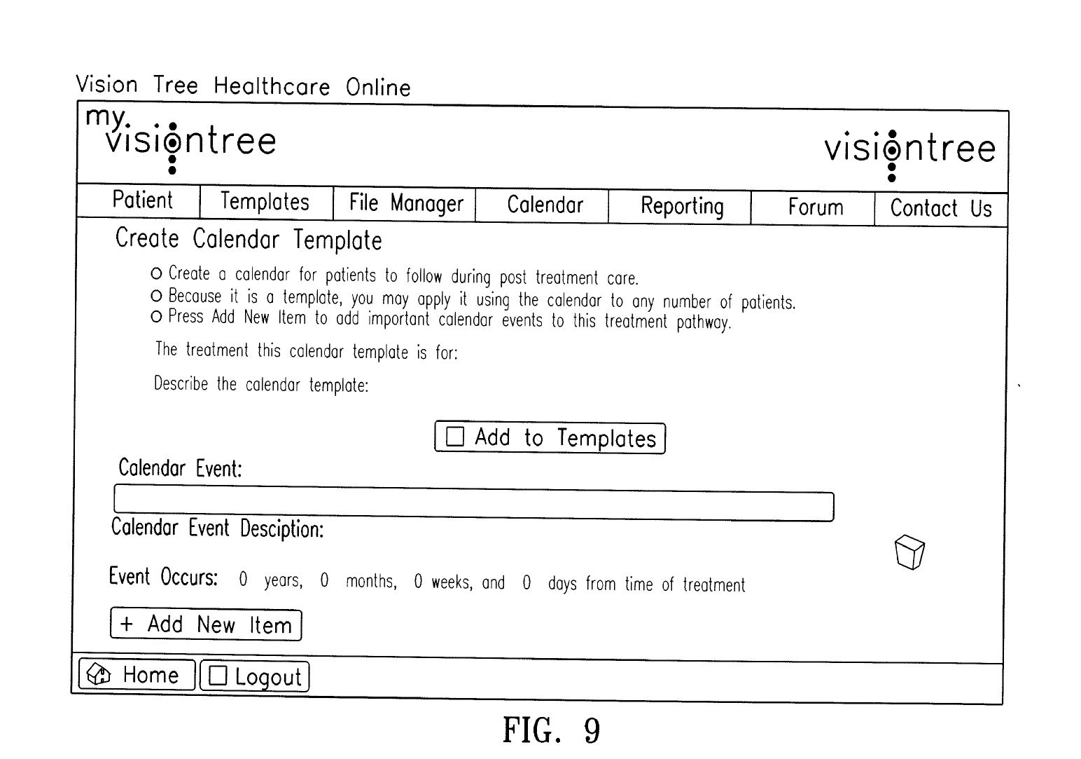

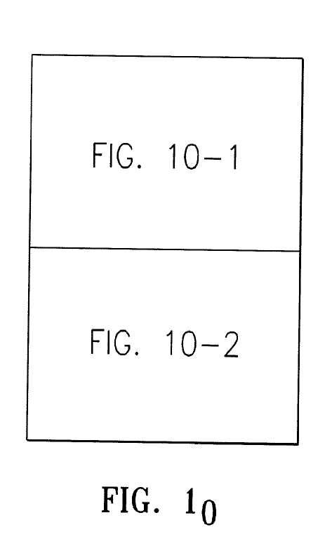

Another feature of the payer/provider portal is the ability to create and edit medical condition templates (FIGS. 8A-8C) and calendar templates (FIG. 9). These templates may be used, for example, by the decision support and informed consent tools to present patients with treatment options, risks and benefits for a particular medical condition. This functionality is accessed by the “Templates” tab which presents a drop-down menus with selections such as, for example, create and edit medical condition templates, and create and edit calendar templates.

FIG. 8A illustrates an initial screen for creating a medical condition template. A medical condition can be selected via specialty and medical conditions from drop down menus. The condition can be renamed if necessary, and new conditions can be added by not selecting a medical condition from the drop down menu, and then entering the name of the new condition in the “Name/Rename Condition” box. FIG. 8B shows an exemplary step in the template creation process, wherein various options for treatment associated with the medical condition, and risk and benefit factors associated with each option, are entered. FIG. 8C is another exemplary step in the process, wherein the payer/provider confirms ratings for the various clinical options and provides other comments for the patient.

FIG. 9 illustrates a screen for creation of a calendar template, wherein a payer/provider may create calendar templates to be applied to various patient calendars. The templates may be used to schedule and manage important tasks, events, etc. in the patient's pre- and post-treatment regimen. The events may be tied to a particular treatment and scheduled to appear in the patient's calendar a certain number of days/months/years from the time of treatment.

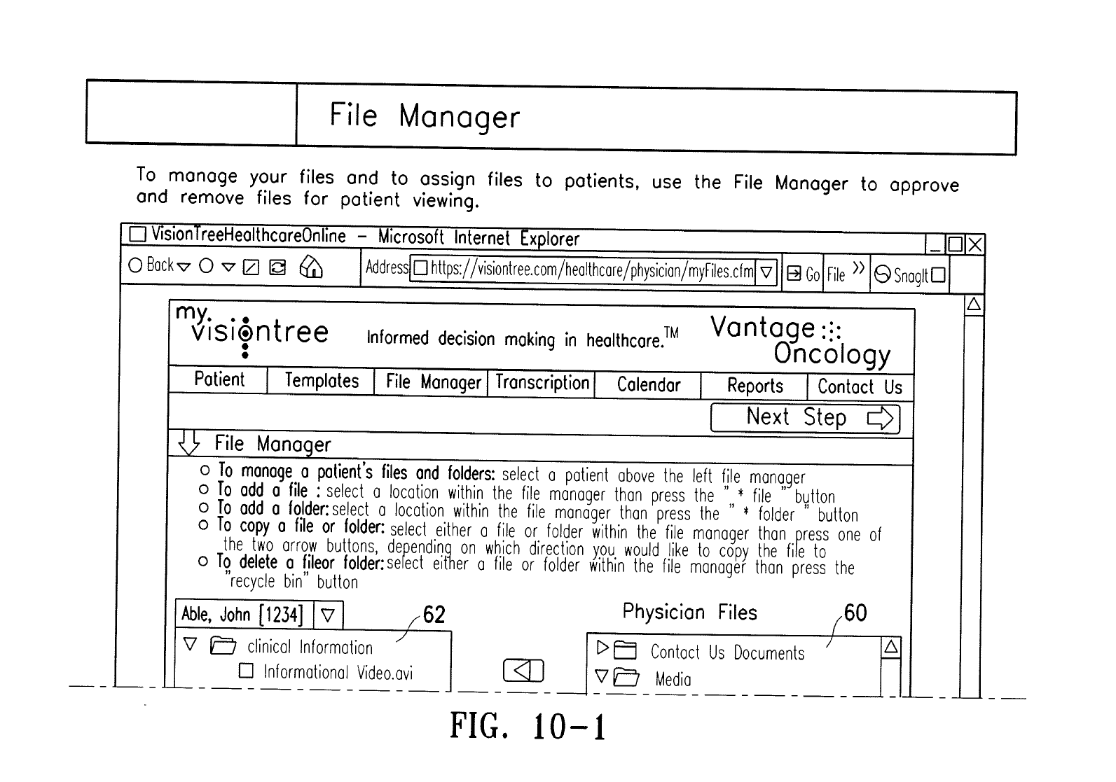

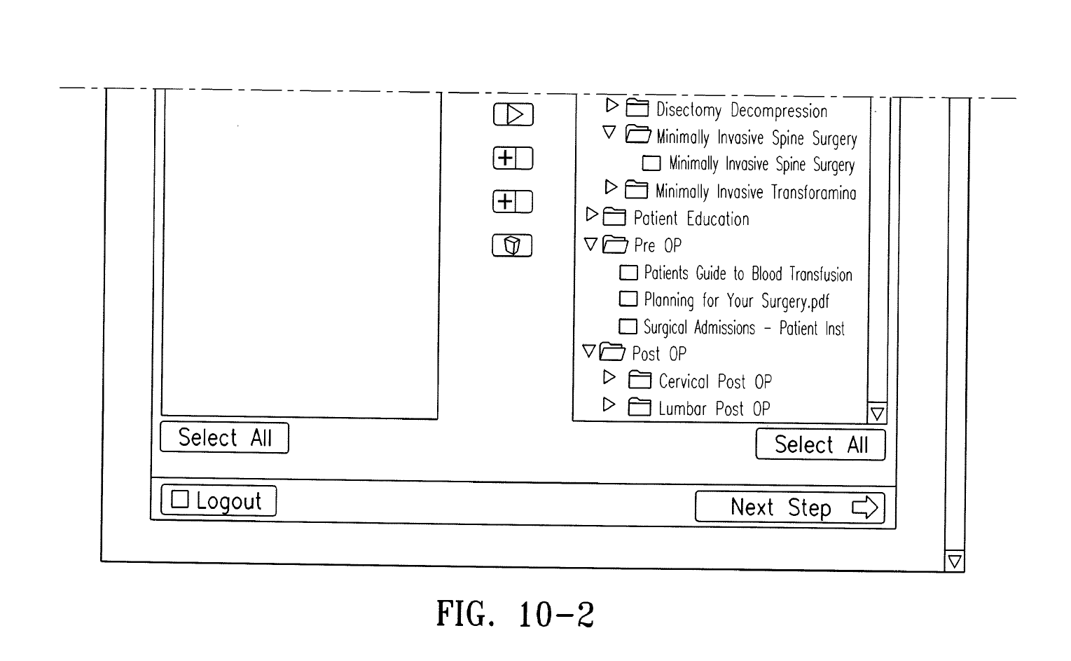

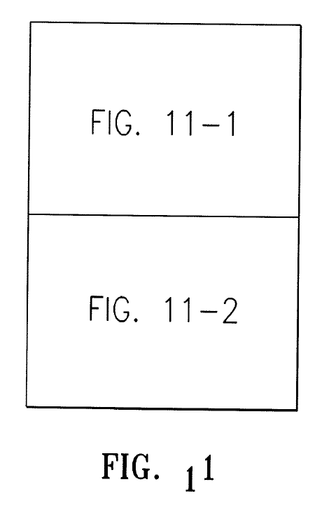

FIG. 10 illustrates one embodiment of a file manager tool. Using the file manager, a payer/provider may manage all of his practice files 60, including such information as reports, surveys, educational material, media and any other documentation relevant to the payer, provider and patients. A payer/provider may upload, approve and remove files, documents and other media for patient viewing, for example, by adding and deleting the files from a patient viewing area 62. The patient can then login and download the files online from the patient portal.

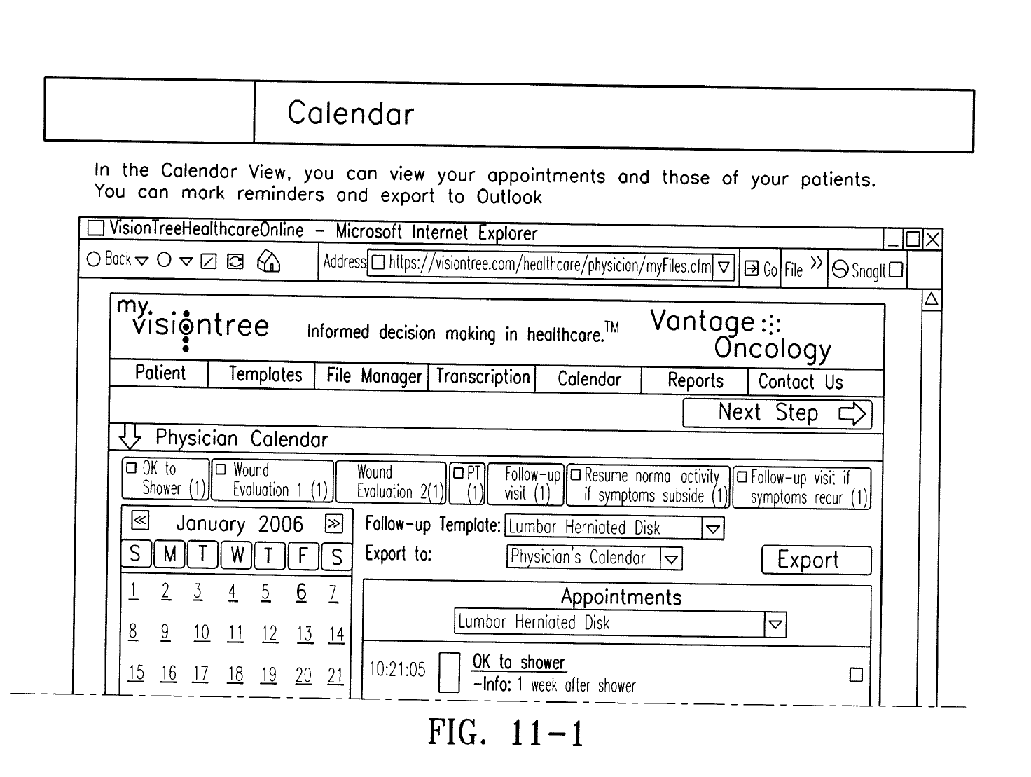

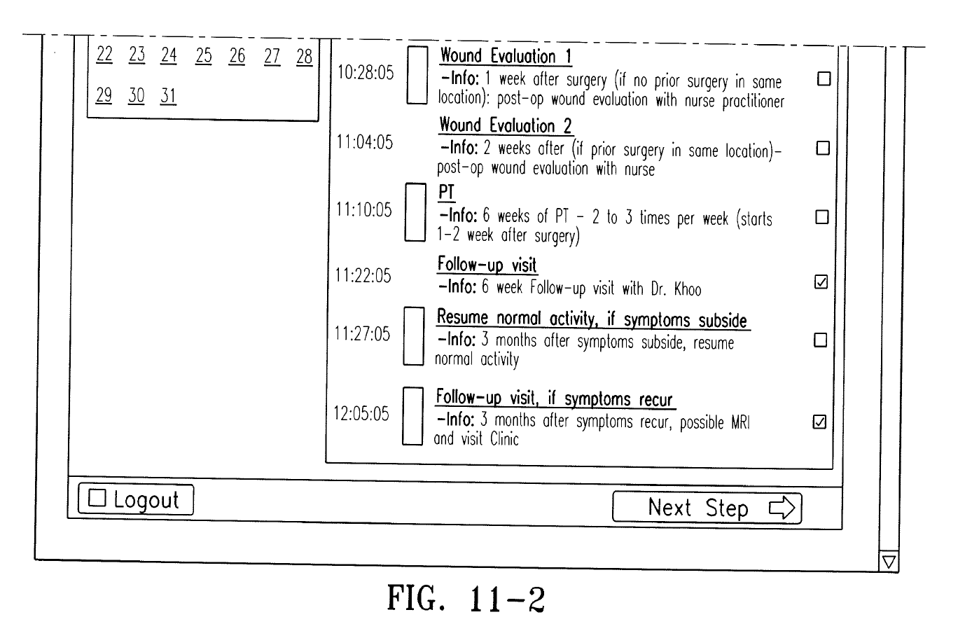

FIG. 11 illustrates an exemplary calendar view (accessed by the calendar tab), where payer and providers can view their appointments as well as those of their patients. Reminder and calendar items can be marked and exported to, for example, Microsoft® Outlook®. The calendar is preferably web-based and thereby accessible by the patient and payer/provider from any location. Selected items may be tracked and a messaging center may be provided to track items of high importance.

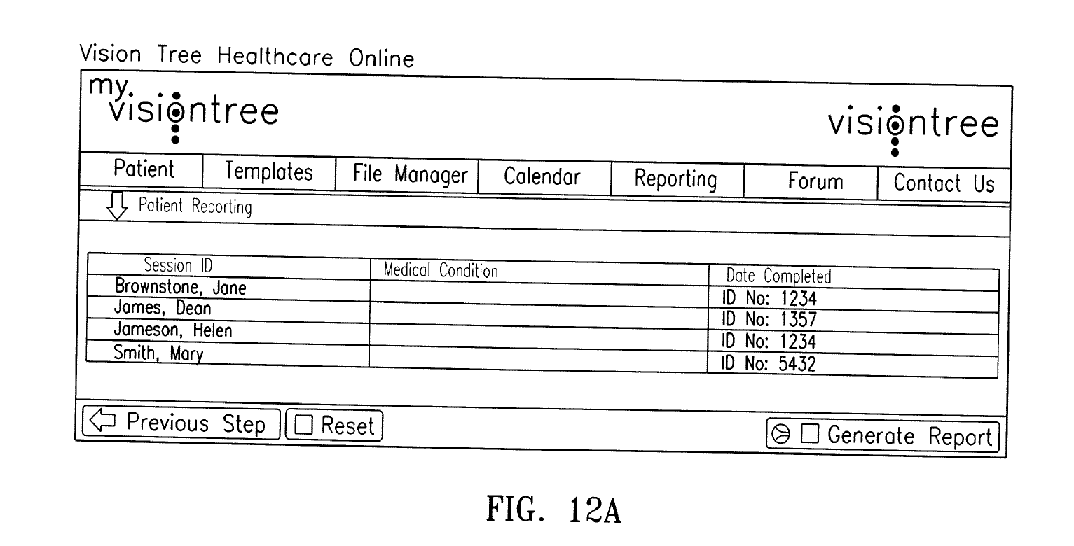

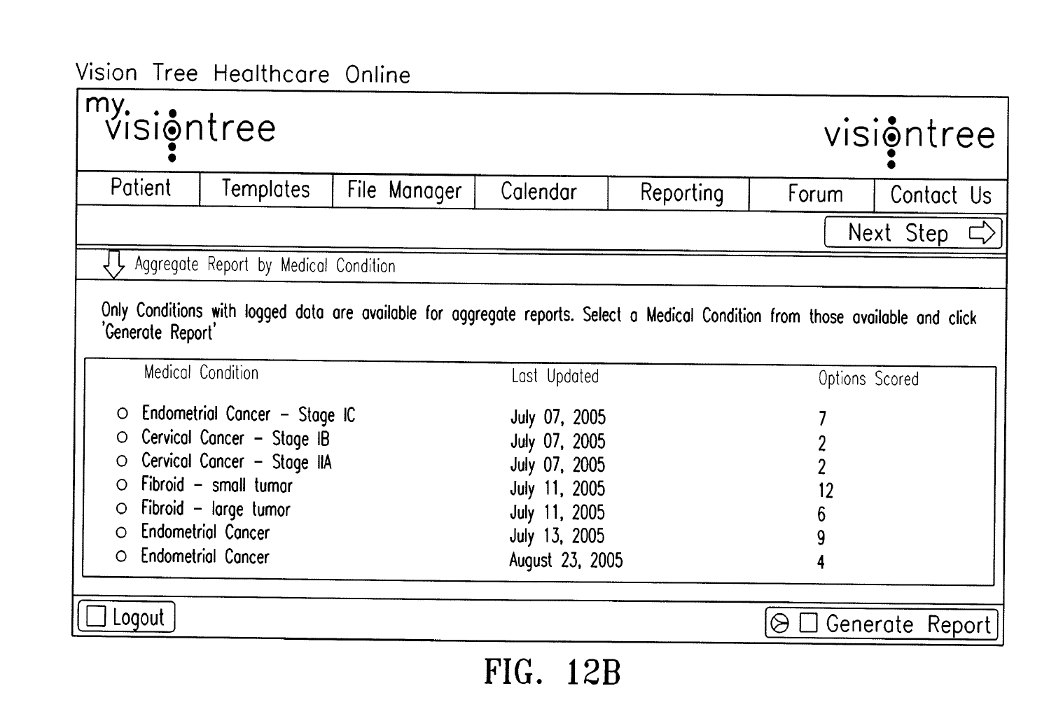

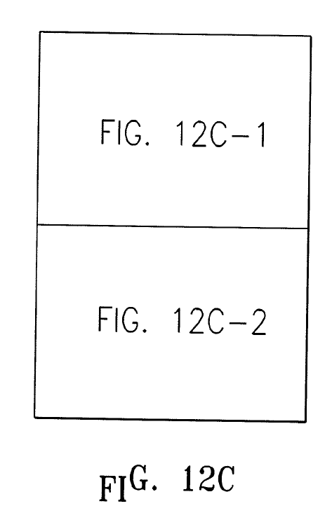

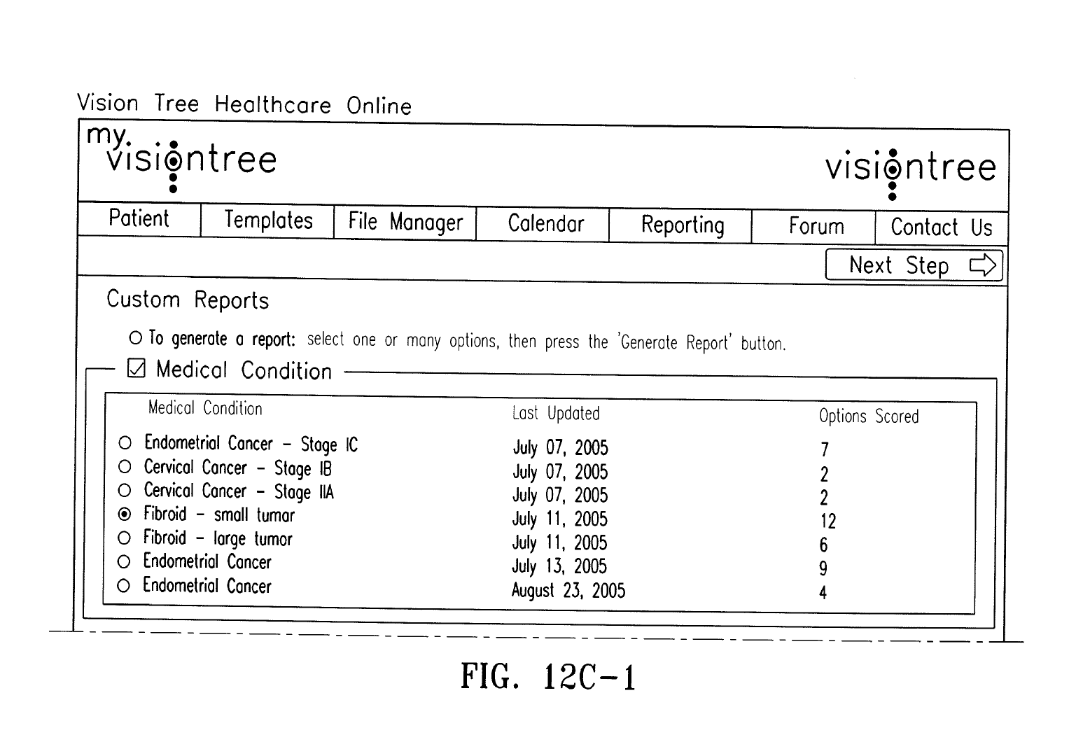

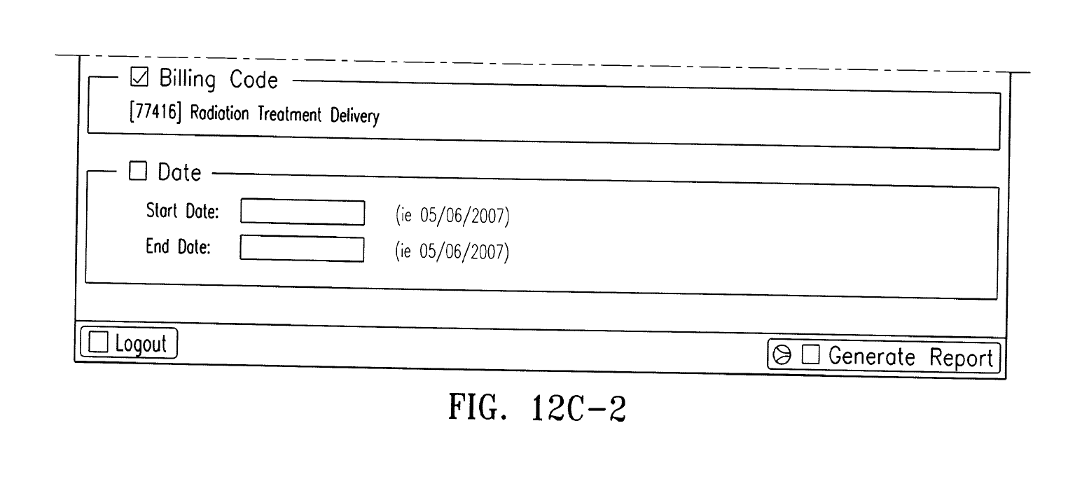

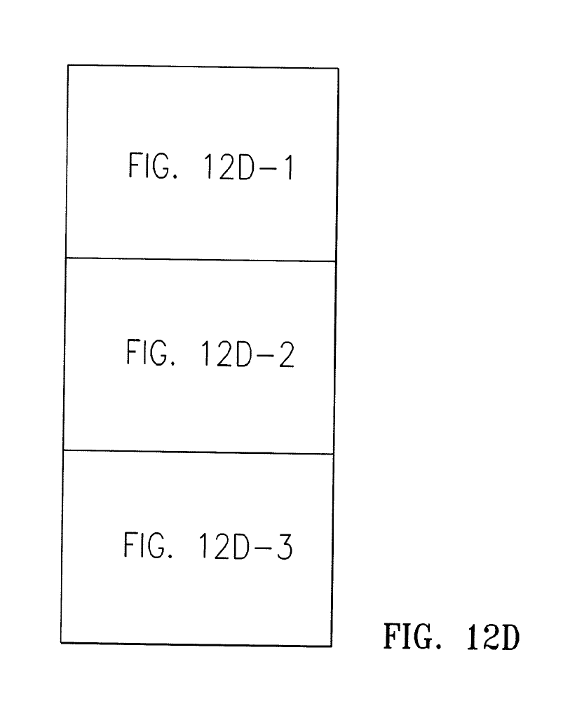

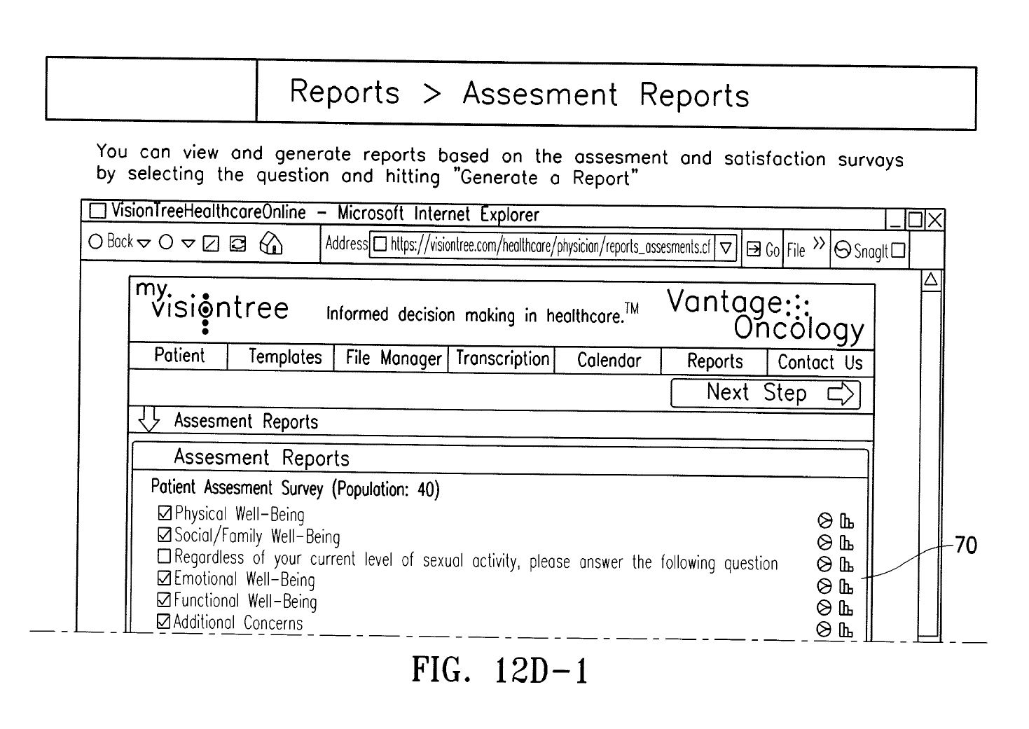

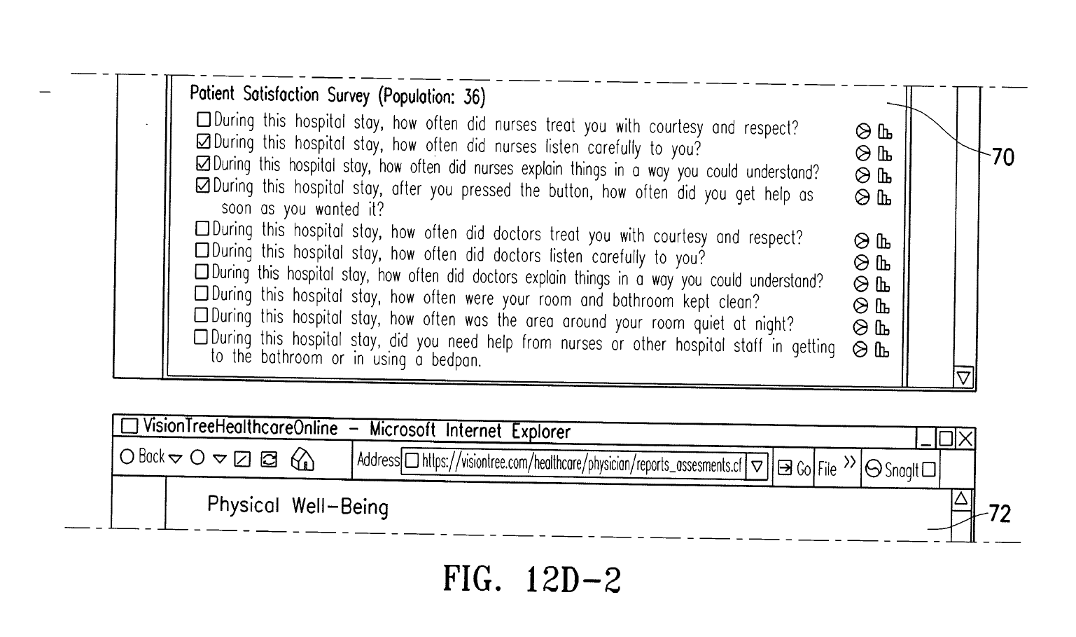

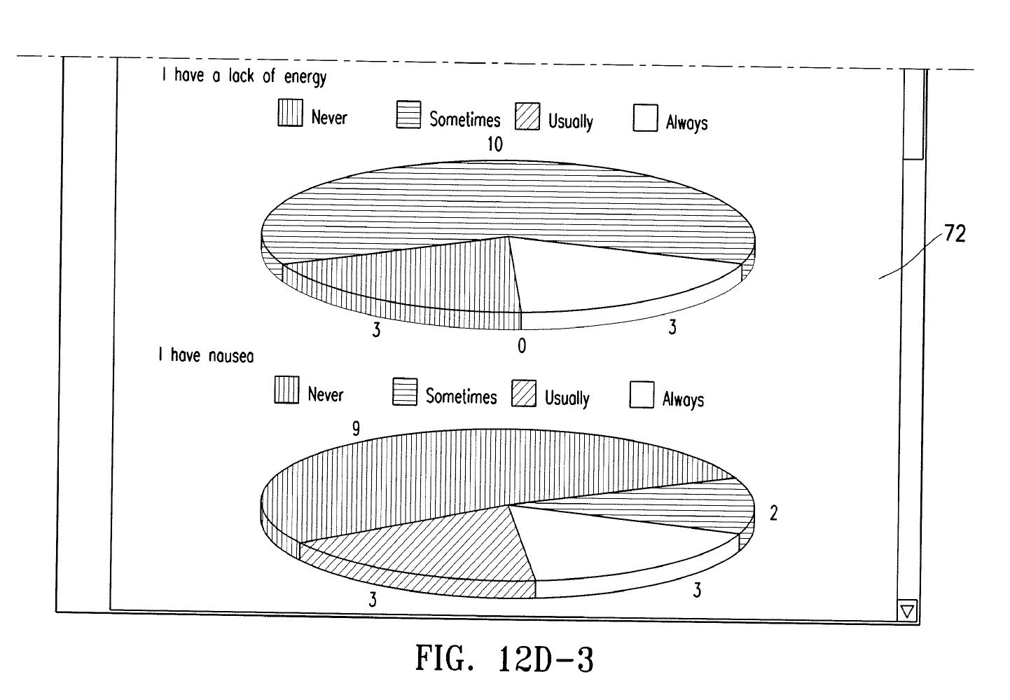

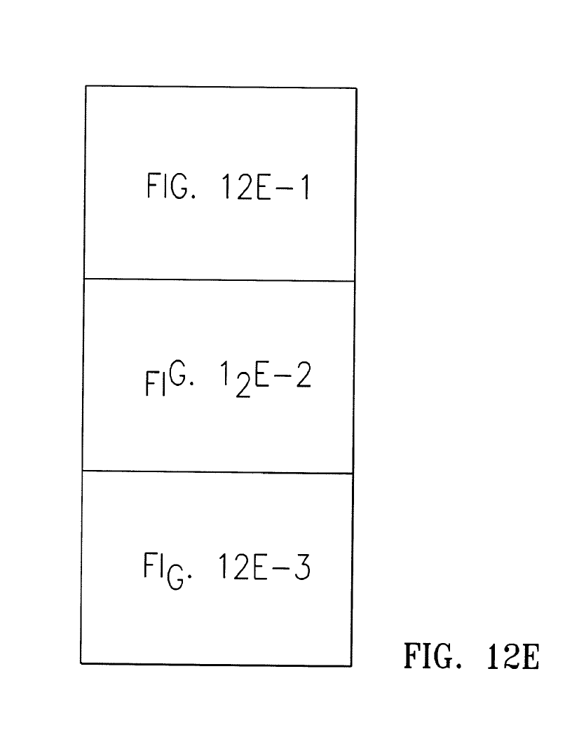

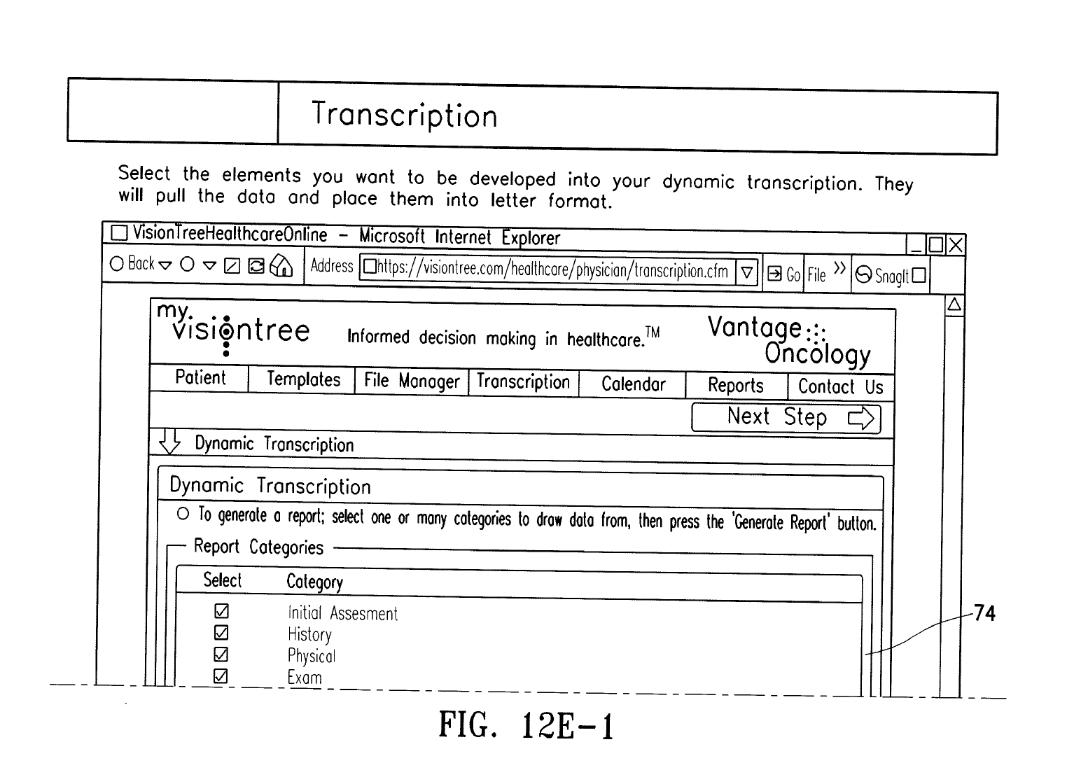

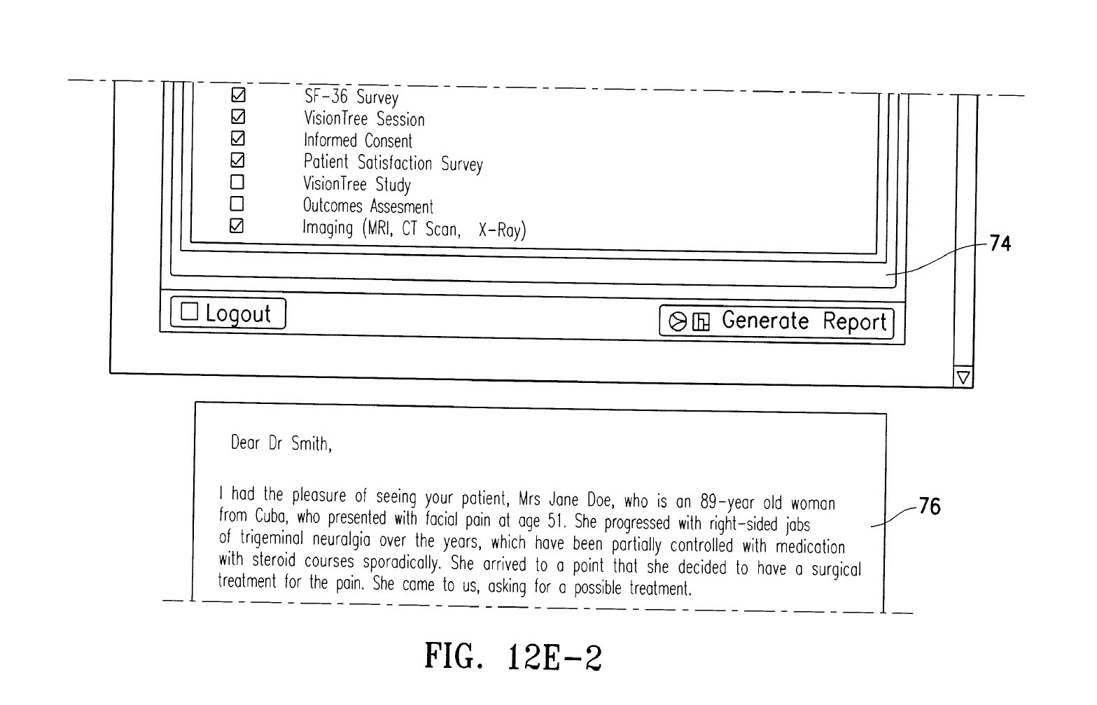

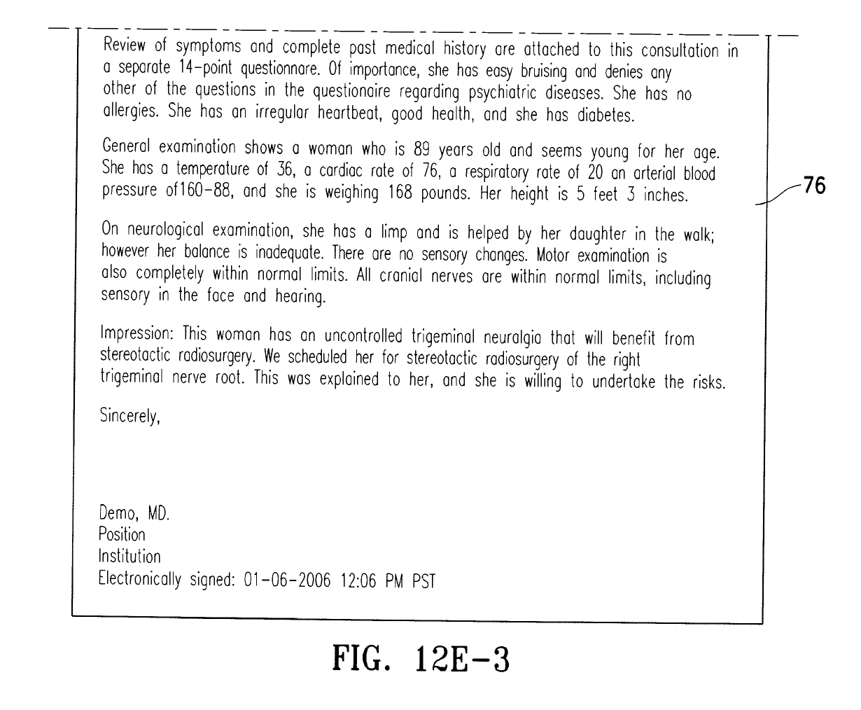

The patient health management portal of the present invention provides the payer/provider with a robust outcomes reporting and tracking tool. Reports may be generated for a specific patient (FIG. 12A). Aggregate reports may be generated by medical condition (FIG. 12B) to provide average scores and responses for all (or a subset of) patients. Custom aggregate reports may also be generated by medical condition, billing code, dates, ICD-9 codes, locations and any other variables or combinations of variables of interest (FIG. 12C).

Aggregate reports can also be generated based on the assessment and satisfaction surveys completed by patients. Thus, reports can be generated for all patients taking a particular assessment or answering a particular question. As shown in FIG. 12D, survey questions of interest may be selected from a screen 70, and a report of the answers generated and graphically displayed in screen 72 in pie graph, bar graph or any other desired format. The ability to generate this wide range of reports based on various comparison queries is of great assistance in implementing quality and efficiency measures.

Another reporting option is dynamic transcription (FIG. 12E). A report 76 can be dynamically transcribed for a particular patient by selecting categories that the data should be drawn from in screen 74 (i.e. history, physical, exam, etc.). This 5 data is then dynamically configured into letter format to produce a letter 76.

Another type of document that can be generated is an interactive treatment pathway diagram 80, which can be created and populated with the templates described above. Templates may populate “to do's” and “next steps” in the treatment path and can alert payers and providers of status and completion. Quality and efficiency measures are documented and electronically stored with corresponding billing codes.

Patient Portal

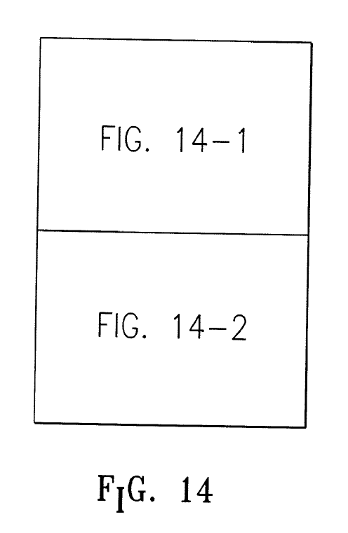

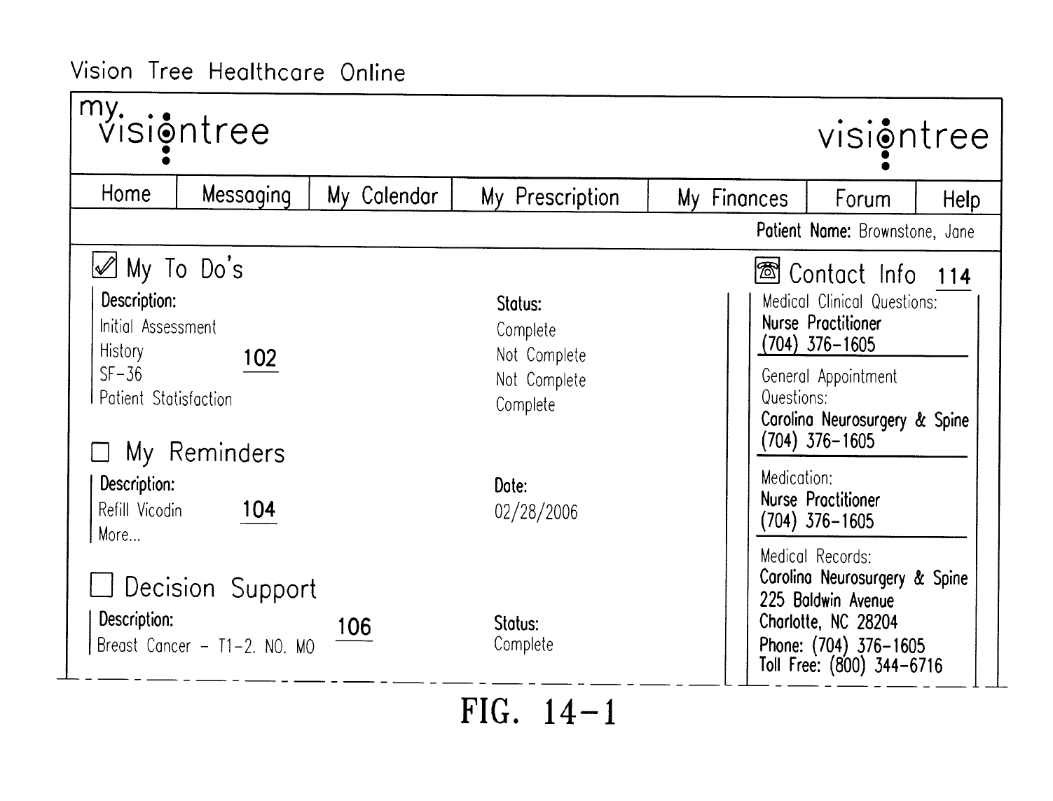

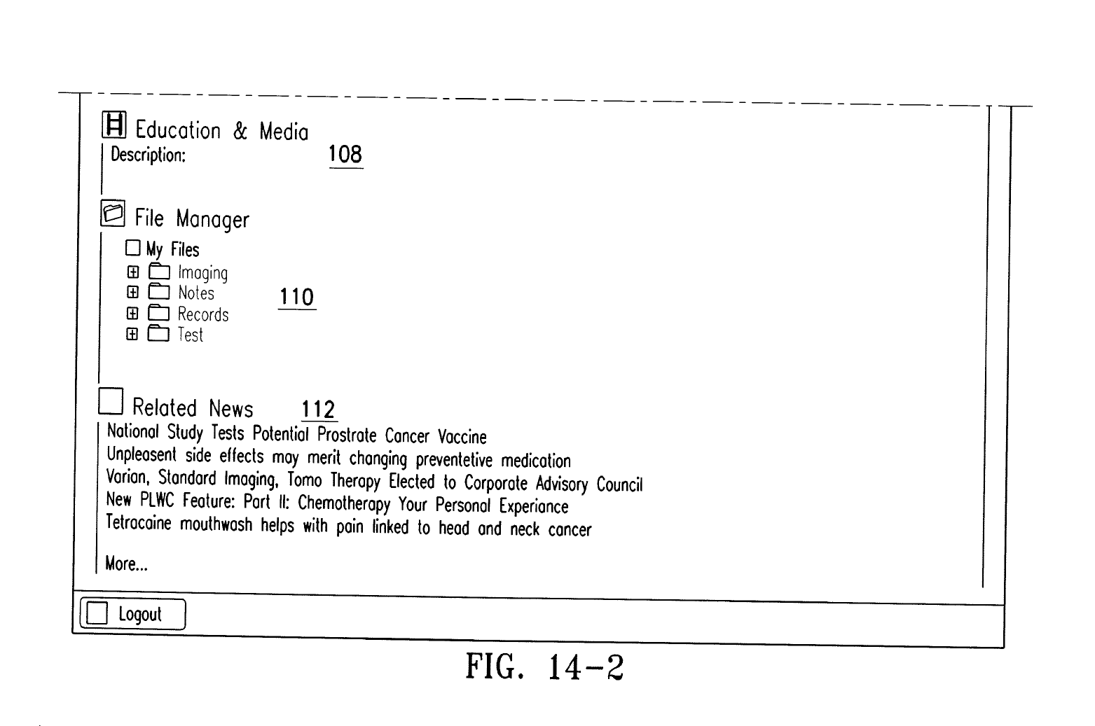

The patient health management portal is now described from the patient's perspective. Once the payer or provider has set up the portal, the patient is provided with an ID card (HIP AA compliant) and instructed to login at an appropriate website (i.e. www.myvisiontree.com). As previously noted, the client (i.e. patient) to server interaction is ensured at a minimum of 128-bit SSL encryption. The server has its own security certificate and data encryption. The patient may also give temporary guest account access to consented read-only forms and files. A unique password with expiration date is generated by the system for each guest account. As shown in FIG. 14, the patient's home screen 100 may be similar to the payer/provider's home screen, with fields for tasks (“to do's”) 102, reminders 104, decision support 106, education and media 108, file manager 110, related news 112 and contact information 114 provided. Clickable, patient-geared tabs 116 are provided for easy navigation (.i.e., messaging, my calendar, my prescriptions, my finances, forum).

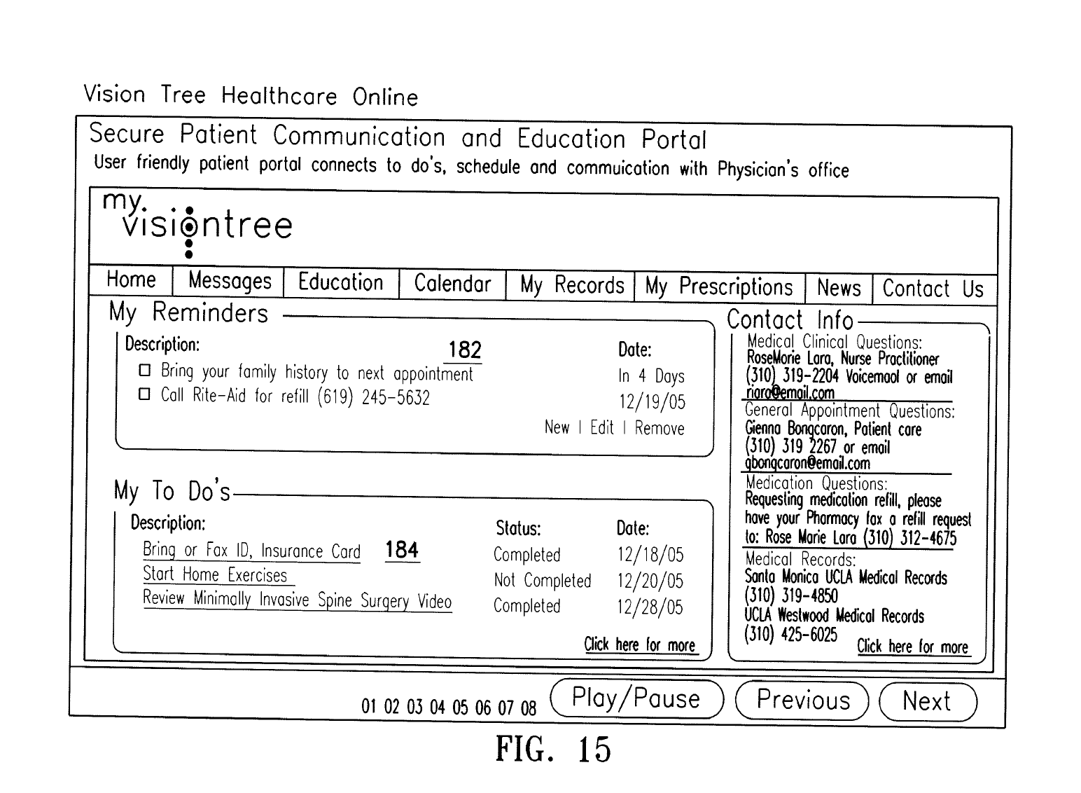

FIG. 15 is another exemplary screenshot of typical patient reminders 102 and tasks 104. Reminders and to do tasks may include treatment pathway-specific items such as what should be brought to the next appointment, prescriptions, exercise and educational material review. The assigned items may be completed by the patient by clicking on the link and answering the questions presented or providing needed information. The tasks may be as simple as confirming that a prescription was obtained, or they may be more involved such as completing a history or survey, or completing an informed consent, as was discussed above with reference to FIGS. 4-5. Some of these forms may be completed out before an office visit (i.e. history, pre/post treatment assessments, etc.). All such forms will be date/time stamped, stored electronically and available for the payer/provider to review prior to the visit. Thus, the patient's visit will be more time efficient and the payer/provider will be better prepared.

As discussed previously in reference to the payer/provider portal, the patient is provided with access to a decision support tool 108. Tool 108 functions as described with reference to the payer/provider portal and FIGS. 6A-E. Reference is again made to applicant's U.S. Pat. No. 6,917,928 and pending application Ser. No. 10/845,301 (US 2004/0220834) to decision engine technology. Decision support tool 108 is advantageous in that it educates patients and adds confidence in their understanding of their options, risks and possible complications. Likewise, it assists payers and providers in documenting informed consent.

The patient is presented with treatment options for consideration (FIG. 6A). If the patient has already made a decision, the patient may opt to view clinical information only rather than going through the decision process. The patient is presented with clinical information graphically comparing the risks and benefits of various treatment options and with links to payer/provider comments, literature, clinical resources, risk charts and outcomes databases (FIG. 6B). Next, preferably using sliding scales, the patient rates the importance of each factor to their overall treatment option decision (FIG. 6C). As shown in FIG. 6D, the patient enters specific concerns they may have for each treatment options and, if there is a specific concern, rates using a sliding scale their willingness to choose the given treatment option. Finally, the treatment options are scored and presented in rank order of which best meets their needs based on the clinical information, importance and willingness ratings provided (FIG. 6E).

As shown in FIG. 14, the patient also has access to a file and information management tool 110. Using this tool, a patient can securely store, upload and download all of their health care records, as well as any other media, educational materials, etc., from any desktop, and share information as they desire with other payers and providers across multiple treatment pathways. In addition, the education and media portal 108 and news portal 112 provides access to important and timely information of relevance to a patient's condition. This may be via links to literature and resources and, in one embodiment, news portal 112 provides live XML and RSS feed from healthcare and news sites.

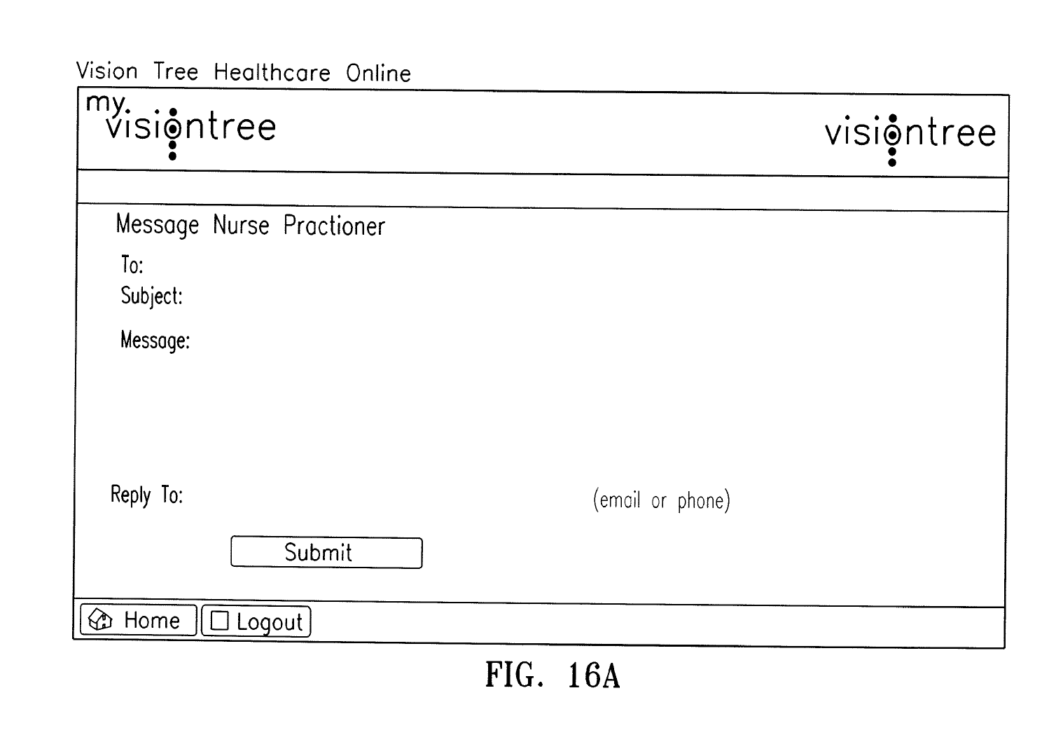

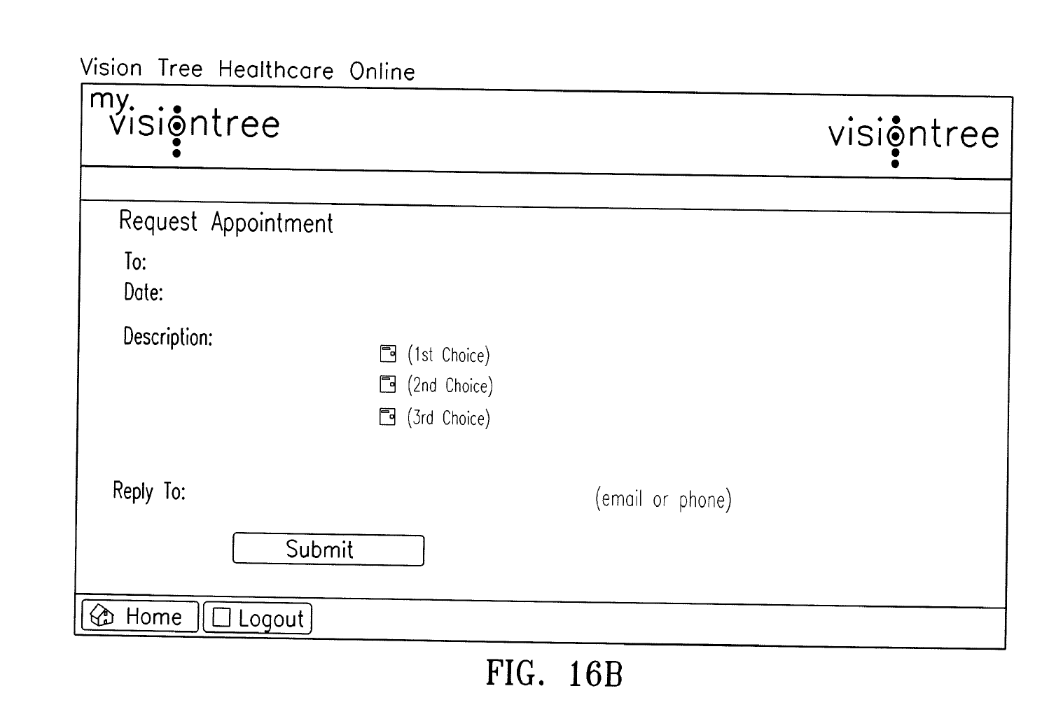

The messaging system, accessed via the messaging tab in tabs portion 116, permits the patient to easily send a message to their payer, provider or medical team. For example, the patient may message their nurse practitioner with a question or request an appointment with their payer/provider. FIG. 16A illustrates an exemplary form for messaging a nurse practitioner, accessed by choosing “contact nurse” or the like from a drop-down menu underneath the messaging tab. The patient is able to easily send a message directly to their nurse, along with a message and identification of who the reply should be sent to. FIG. 16B illustrates an exemplary form for requesting an appointment, accessed by choosing “request appointment” or the like from a drop-down menu underneath the messaging tab. The patient can easily request an appointment and include first, second, third, etc. choices for the date.

A patient may view and manage their calendar and reminders via the “My Calendar” tab (or the like). The calendar is preferably web-based and accessible by the patient and payer/provider from any location.

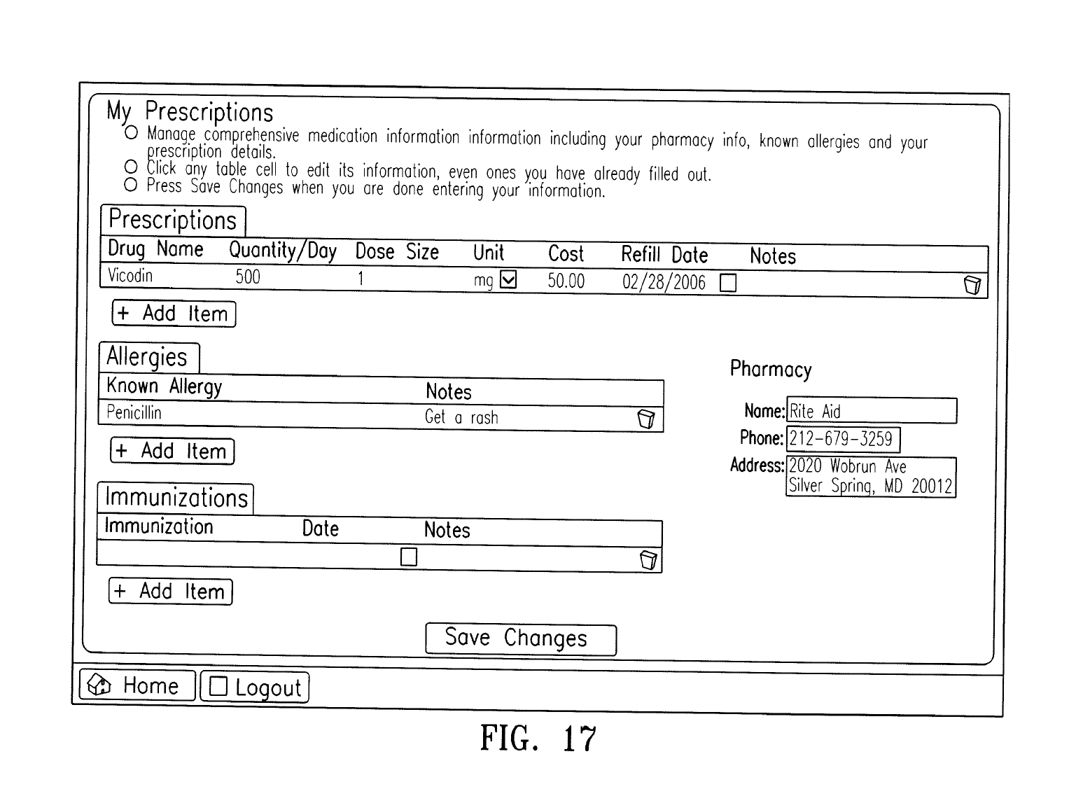

The patient portal also provides a tool for a patient to manage and track their drug prescriptions. Using the “My Prescriptions” tab, a patient is able to complete a form adding their prescriptions to the database (FIG. 17). Prescriptions may be tracked by such variables as drug name, quantity/day, dose size, cost and refill date. Refill dates may be automatically posted to the patient's calendar and reminders. Other notes relevant to a prescription may also be entered. A patient's allergies, immunizations and pharmacy references are also stored and editable. Utilizing the “My Prescriptions”, physicians cane-prescribe the medications to their patients and enter in the fax number for the patient's pharmacy. The system also checks with a drug database for interactions and dosage requirements. The system checks dosing, interactions and formularies of prescriptions that are being written. Multiple prescriptions and refills can be written and sent to a pharmacy's facsimile machine. Commonly written prescriptions can be saved to a favorites list, and prescription audit reports with various options can be printed.

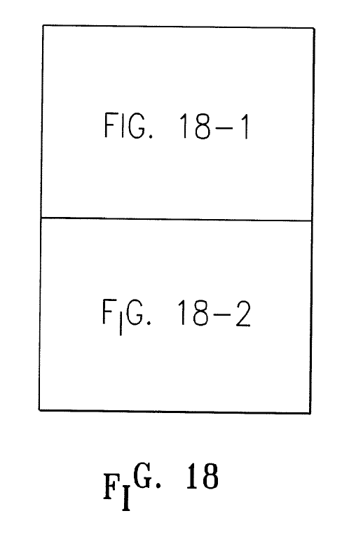

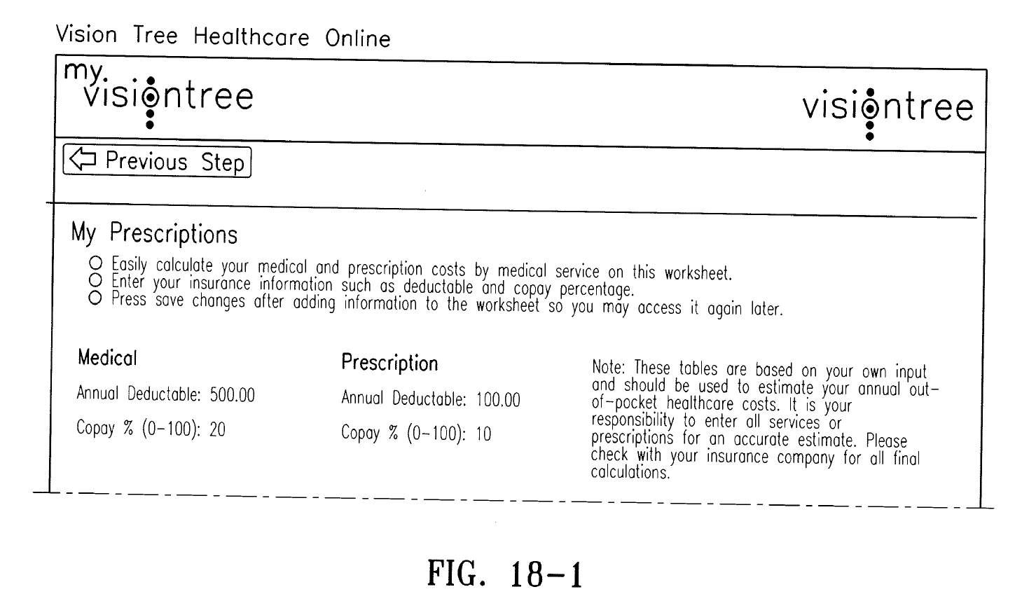

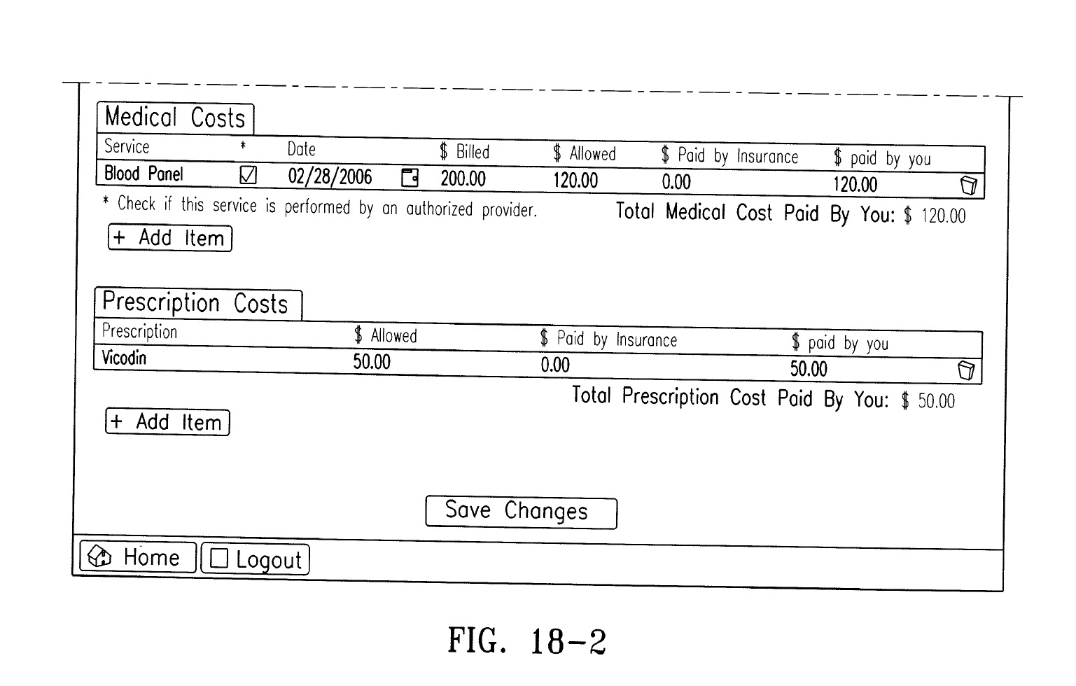

Patients may also manage their healthcare-related finances using the “My Finances” tool. Costs for services and prescriptions, broken down by co-payment, deductibles, allowable and totals may be entered, tracked and managed. As shown in FIG. 18, for each medical or prescription cost, data such as the amount billed, the amount allowed by the insurance company, the amount paid by the insurance company and the amount paid by the patient may be entered. Medical and prescription annual deductibles and co-payments may also be entered. Electronic payment may be processed using the “My Finances” section to pay for web-visits, copays or other medical expenses. The payer or provider can receive these payments from the patient's credit card through the online shopping cart. The web visit links with the corresponding CPT code: 00749T. Using this system, the portal can integrate with the payer or provider's billing system.

Another feature provided by the patient portal is the ability to engage in live discussion forums with other patients and their medical team on particular topics relevant to the patient and their condition.

Finally, it is noted that the patient health management portal of the present invention supports a seamless and meaningful implementation and transition to electronic medical records (EMRs). A large percentage of hospitals are moving to EMRs over the next several years. The portal of the present invention compliments electronic documentation and provides an easy starting point with no significant changes to medical team workflow to advantageously utilize the data in EMRs. In this regard, the present invention supports import, export, mining and backup of data for the patient's health records, reports and all data points in a variety of formats, including the data standards for EMRs. The present invention also supports live RSS and XML data feeds for up-to-date prescription and pharmacy information.

The particular embodiments of the invention described in this document should be considered illustrative, rather than restrictive. Modification to the described embodiments may be made without departing from the spirit of the invention as defined by the following claims.

1. A secure online patient health management portal comprising:
a payer/provider portal providing means for patient management; and
a patient portal providing means for personal health management.

2. A patient health management portal as claimed in claim 1, wherein the payer/provider portal comprises means for accessing a plurality of patient accounts, and wherein each patient account comprises a task manager and decision support manager for the patient.

3. A patient health management portal as claimed in claim 2, wherein each patient account further comprises reminders to the patient, educational materials and media of relevance to the patient, news of relevance to the patient and a file manager.

4. A patient health management portal as claimed in claim 2, wherein the task manager comprises electronic forms and surveys to be completed by the patient at appropriate stages of treatment.

5. A patient health management portal as claimed in claim 4, wherein the electronic forms and surveys include an assessment survey, patient history, physical, a satisfaction survey and an outcomes assessment.

6. A patient health management portal as claimed in claim 2, wherein the task manager comprises means for obtaining dynamic informed consent from the patient.

7. A patient health management portal as claimed in claim 6, wherein the means for obtaining dynamic informed consent comprises means for presenting to the patient the medical condition, treatment options, risks and benefits, and means for electronically capturing and storing the signature of the patient.

8. A patient health management portal as claimed in claim 2, wherein the decision support manager comprises:
means for presenting to the patient the medical condition and treatment options;
means for presenting to the patient clinical data associated with each treatment option;
means for obtaining from the patient a rating of the importance of factors associated with the treatment options;
means for obtaining from the patient identification and rating of specific concerns associated with a condition; and
means for calculating a score associated with each treatment option based on the patient input.

9. A patient health management portal as claimed in claim 2, and further comprising means for creation of medical condition templates by the payer or provider including options for treatment associated with medical conditions and risks and benefit factors associated with each option.

10. A patient health management portal as claimed in claim 2, and further comprising an outcomes reporting and tracking tool comprising means for generating reports for a specific patient, means for generating aggregate reports by medical condition and means for generating custom aggregate reports.

11. A patient health management portal as claimed in claim 10, wherein the outcomes reporting and tracking tool further comprises dynamic transcription means for generating a report by selecting categories of data that should be included in the report.

12. A patient health management portal as claimed in claim 1, wherein the patient portal comprises a reminder and task manager and a decision support tool.

13. A patient health management portal as claimed in claim 12, wherein the reminder and task manager comprises means for confirming that a prescription was obtained; means for completing surveys; and means for completing informed consent forms.

14. A patient health management portal as claimed in claim 12, wherein the decision support tool comprises:
means for reviewing medical condition and treatment options;
means for reviewing clinical data associated with each treatment option;
means for rating importance of factors associated with the treatment options;
means for identifying and rating specific concerns associated with a condition; and
means for calculating and displaying a score associated with each treatment option based on the patient input.

15. A patient health management portal as claimed in claim 12, wherein the patient portal further comprises means for downloading a patient's health care records.

16. A patient health management portal as claimed in claim 12, wherein the patient portal further comprises a messaging system that includes means for sending a message to a medical team member, and means for requesting an appointment.

17. A patient health management portal as claimed in claim 12, wherein the patient portal further comprises means for managing and tracking drug prescriptions.

18. A patient health management portal as claimed in claim 12, wherein the patient portal further comprises means for managing healthcare-related finances.

19. A patient health management portal as claimed in claim 18, wherein the means for managing healthcare-related finances comprises means for entering, tracking and managing medical and prescription costs, costs paid by insurance company, costs paid by patient, deductibles and co-payments.

20. A secure Internet-based method for managing healthcare comprising:
providing payer/provider access to a plurality of patient accounts;
providing electronic forms and surveys to be completed by a patient at various stages of treatment;
informing the patient of a medical condition, treatment options, risks and benefits and electronically capturing and storing a signature of the patient indicating the patient's consent;
assisting the patient with a treatment decision by obtaining ratings of importance of benefits, risks and concerns associated with each treatment option and calculating a score for each treatment option;
generating patient, medical condition and custom aggregate reports;
providing means for a patient to download his/her health care records;
providing means for a patient to manage and track drug prescriptions; and
providing means for a patient to manage and track healthcare-related expenses.
